(19) United States
(12) Patent Application Publication
(10) Pub. No.: US 2011/0132900 A1
(43) Pub. Date: Jun. 9, 2011

(54) HEAT COOKING DEVICE

(75) Inventors: Hirokazu Kinoshita, Saitama (JP); Haruyo Gotoh, Saitama (JP); Hiromi Satoh, Saitama (JP); Jun Bunya, Saitama (JP)

(73) Assignees: MITSUBISHI ELECTRIC CORPORATION, Chiyoda -ku (JP); MITSUBISHI ELECTRIC HOME APPLIANCE CO., LTD., Fukaya-shi (JP)

(21) Appl. No.: 13/002,350

(22) PCT Filed: May 8, 2009
(86) PCT No.: PCT/JP2009/058658

§ 371 Date: Jan. 3, 2011

(30) Foreign Application Priority Data
Aug. 8, 2008 (JP) 2008-205715

(51) Int. Cl. H05B 6/06; H05B 3/68

(52) U.S. Cl. 219/647; 219/443.1

(57) ABSTRACT

Information means 100 that displays operation and setting information or operation conditions information input from operation means has a display face of information overlapped for plurality of layers. Information displayed on the display face is formed of segments. Segments are arranged in such a way that segments provided for displaying information do not overlap when displaying information on the display faces of a different layer simultaneously.

### TECHNICAL FIELD

The present invention relates to a heat cooking device provided with a multiple layer structured display device.

### BACKGROUND ART

As an electromagnetic cooker that heats an upper face of a body (chassis) by one or a plurality of electromagnetic induction heat sources and a complex type cooker that can perform heating by a radiation type heat source as well as the electromagnetic induction heat source, a conventional heat cooking device is, for example, an induction heat cooking device that is provided with “a top plate that configures an upper face of the cooking device body and on whose heating section heated cooking utensils are mounted, heating means that heats the heated cooking utensils mounted on the heating section, a temperature sensor that is arranged at the lower side of the heating section, operation means that performs setting operation regarding the control of the induction heating, heating control means that controls the heating means based on the setting operation, and display means that displays the cooking setting conditions and progress status of cooking in the operation means”. The induction heat cooking device is proposed using a fluorescent display tube as display means. (Patent Literature 1, for example)

The induction heating device is also proposed provided, for example, with “a body having a cooking warehouse inside, a top plate arranged on the upper face of the body, a heating section that is arranged at the lower section of the top plate and heats a cooking pot mounted on the top plate, a control section that controls operation of a heater of the cooking warehouse and the heating section, an operation section that inputs heating conditions of the heating section to the control section, and a display section that displays conditions set by the operation section”, using liquid crystal as the display section. (Patent Literature 2, for Example)

### CITATION LIST

### Patent Literature

Patent Literature 1 Japanese Patent No. 2006-3047 (page 4-5, FIG. 1)
Patent Literature 2 Japanese Patent No. 2005-56722 (page 4-5, FIG. 6)

### SUMMARY OF INVENTION

### Technical Problem

In a conventional heat cooking device, display means using fluorescent display tubes and liquid crystal and the like is arranged on a top plate. Display devices arranged on the top plate facilitate to visually confirm operation conditions displayed on the display device while operating the heat cooking device. However, an appropriate area is required according to an amount of information to be displayed for the display face of the display device. Especially, a larger area is necessary to display information on a plurality of heat sources, however, the display device to be arranged on the top plate, which is a cooking face, has a restriction on space. Accordingly, when displaying information corresponded to a plurality of heat sources, characters have to be made small, resulting in deterioration of usability inadvantageously.

As for liquid crystal, which is one of display devices, a variety of operation conditions were displayed using dot matrix liquid crystal in the past. However, parts cost is high and dedicated microcomputers and memories for accommodating dot matrix data are needed, resulting in cost increase more than necessary and complex control inadvantageously.

Character information calling for attention is required when using the heat cooking device in many cases. However, its contents are not likely to be displayed for the user to visually confirm with ease.

The present invention is made to solve the above problems and its object is to provide a heat cooking device that can simply display as much information as possible in a limited arrangement space.

### Solution to Problem

A heat cooking device according to the present invention includes a body, a top plate that covers an upper face of the body and on which an object to be heated is placed, a plurality of heating means that is arranged on the lower side of the top plate and heats the object to be heated, control means that controls operation of the heating means, operation means that inputs operation and setting information of the cooking device into the control means, and information means that displays the operation and setting information input from the operation means or information on operation conditions. The information means uses a display device such that a display face of information overlapped by a plurality of layers is provided, information displayed by the display face is formed by segments, and the segments are arranged so that the segments provided for displaying information do not overlap when information is simultaneously displayed on the display face in a different layer.

### Advantageous Effects of Invention

In the present invention, atop plate that covers the upper face of the body and on which an object to be heated is placed, a plurality of heating means that is arranged below the top plate and heats the object to be heated, control means that controls operation of the heating means, operation means that inputs operation and setting information of the cooking device into the control means, and information means that displays the operation and setting information input from the operation means or information on operation conditions are provided. Since the information means uses a display device that has a display face of information in which a plural layers are overlapped, information displayed by the display face being formed by segments, and the above-mentioned segments are arranged so that segments provided for supplying information do not overlap when information is simultaneously displayed on the display face in a different layer, it becomes possible to overlap and arrange segments having no need to simultaneously display, therefore, it is possible to provide a heat cooking device that displays much information with characters having improved visibility in a limited space.

### BRIEF DESCRIPTION OF DRAWINGS

FIG. 1 is an exploded perspective view showing a heat cooking device body according to Embodiment 1.

FIG. 2 is a perspective view showing a top board and the entire body part according to Embodiment 1.

FIG. 3 is a plain view partially viewing front of the body part according to Embodiment 1.

FIG. 4 is a plain view of the entire body section according to Embodiment 1.

FIG. 5 is a longitudinal sectional view at the right-half side position of the body section according to Embodiment 1.

FIG. 6 is a longitudinal sectional view showing an induction heating coil section according to Embodiment 1.

FIG. 7 is a longitudinal sectional view at the left-half side position of the body section according to Embodiment 1.

FIG. 8 is a configuration diagram of a control circuit according to Embodiment 1.

FIG. 9 is a longitudinal sectional view showing an end of an upper operation section and a top board section according to Embodiment 1.

FIG. 10 is a longitudinal sectional view showing an end of a top board section according to Embodiment 1.

FIG. 11 is a sectional view of comprehensive display means according to Embodiment 1.

FIG. 12 is a segment arrangement drawing of comprehensive display means according to Embodiment 1.

FIG. 13 is a drawing illustrating a display face of a first layer of comprehensive display means according to Embodiment 1.

FIG. 14 is a drawing illustrating a display face of a second layer of comprehensive display means according to Embodiment 1.

FIG. 15 is a drawing illustrating a display example in the case of driving a first and a second segments of comprehensive display means according to Embodiment 1.

### DESCRIPTION OF EMBODIMENTS

### Embodiment 1

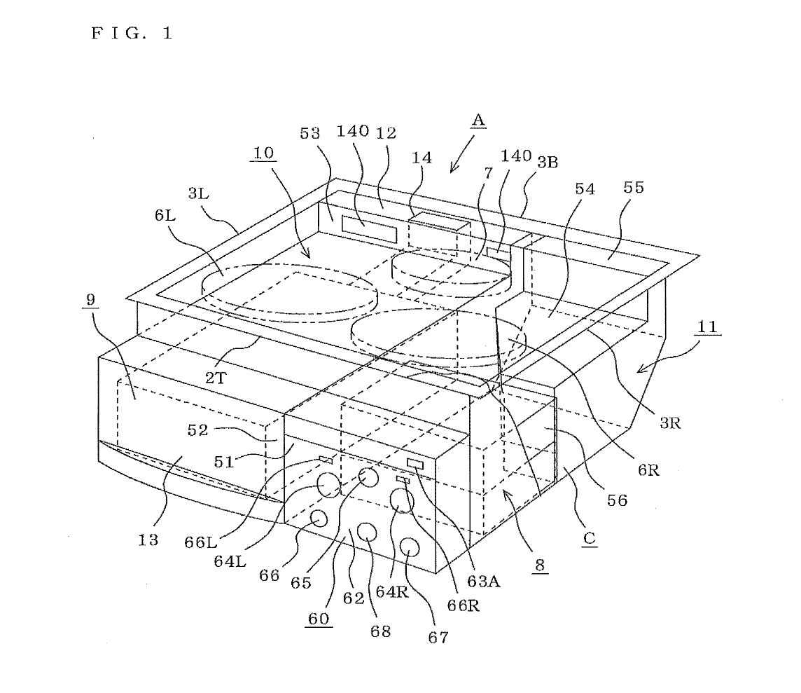

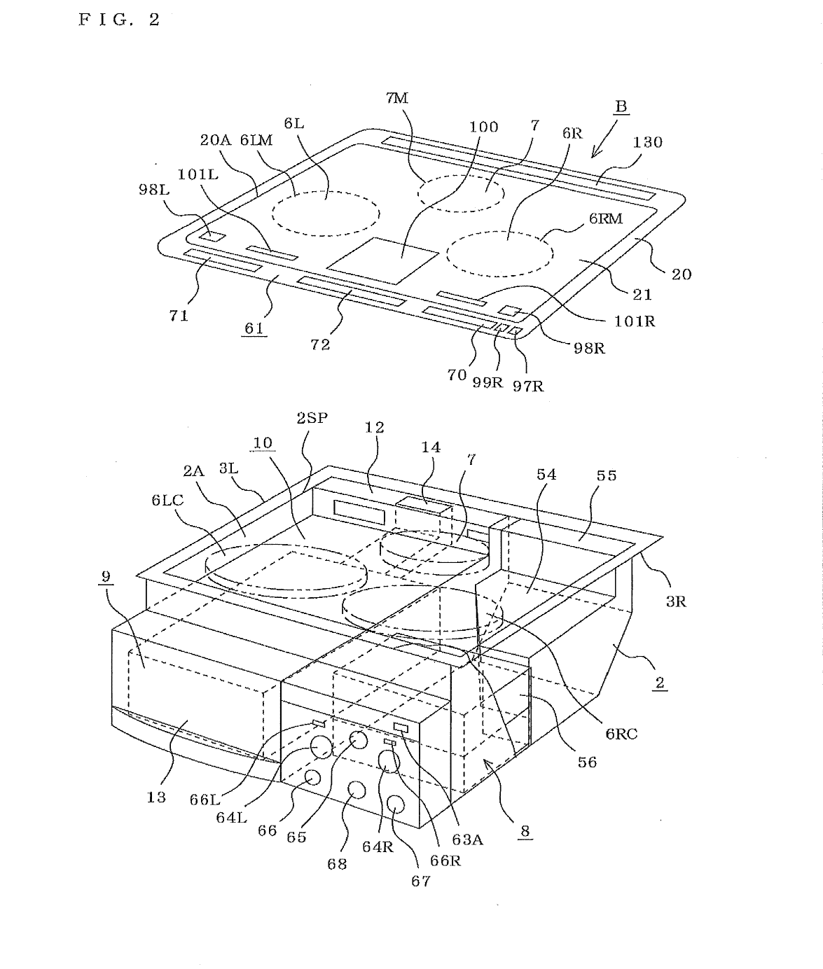

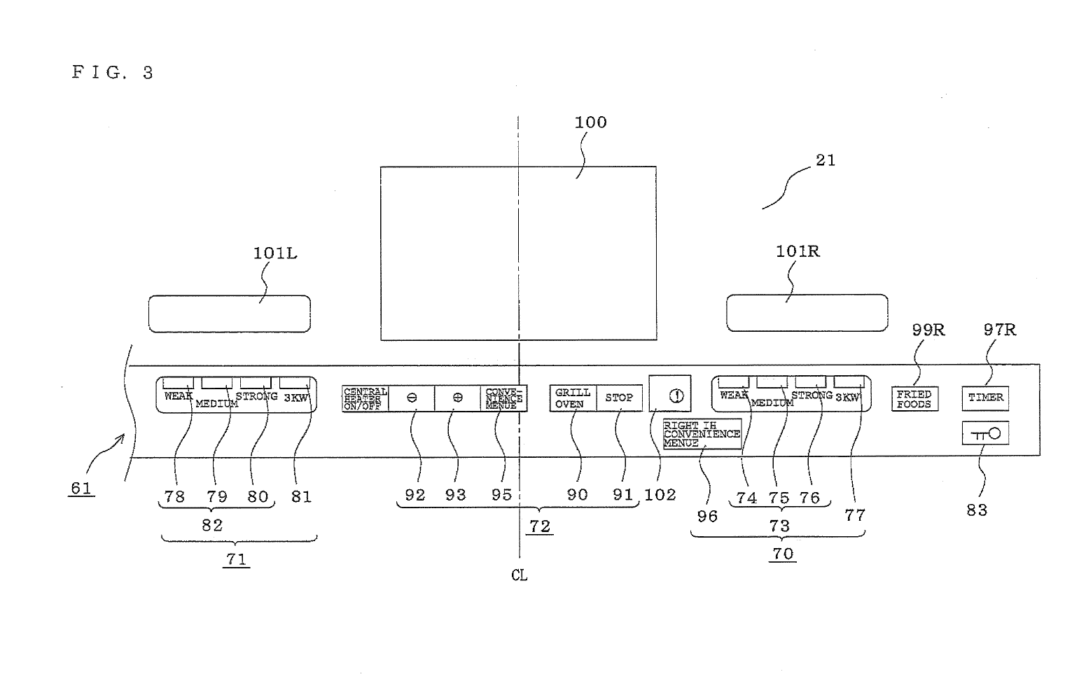

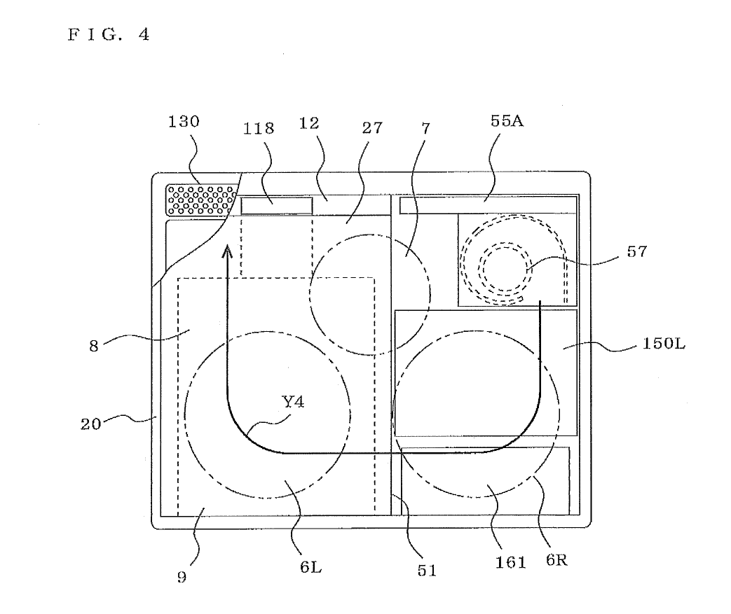

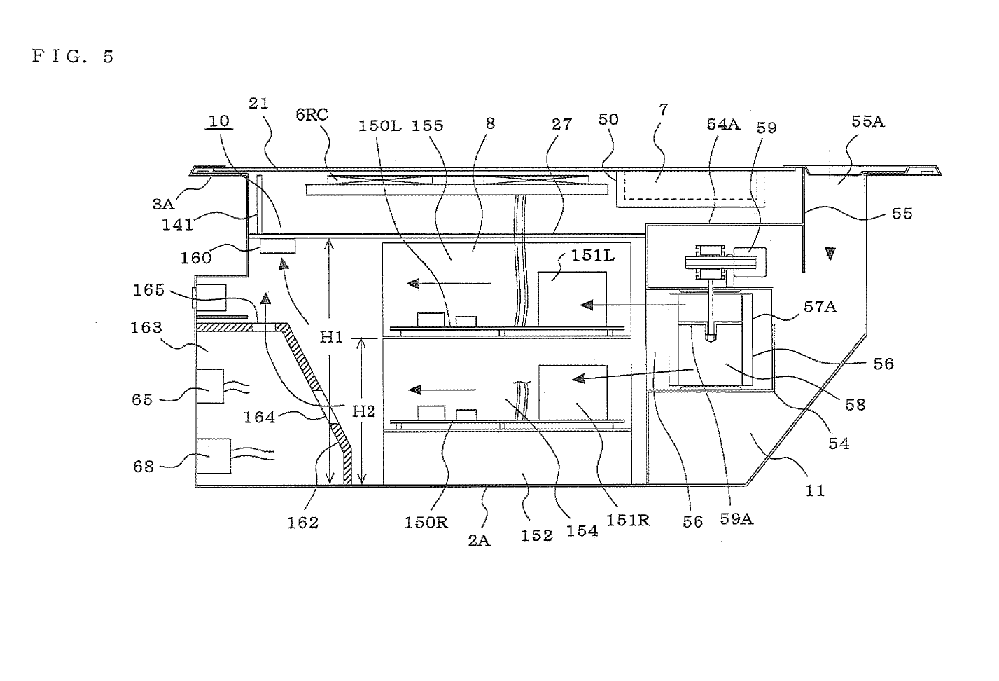

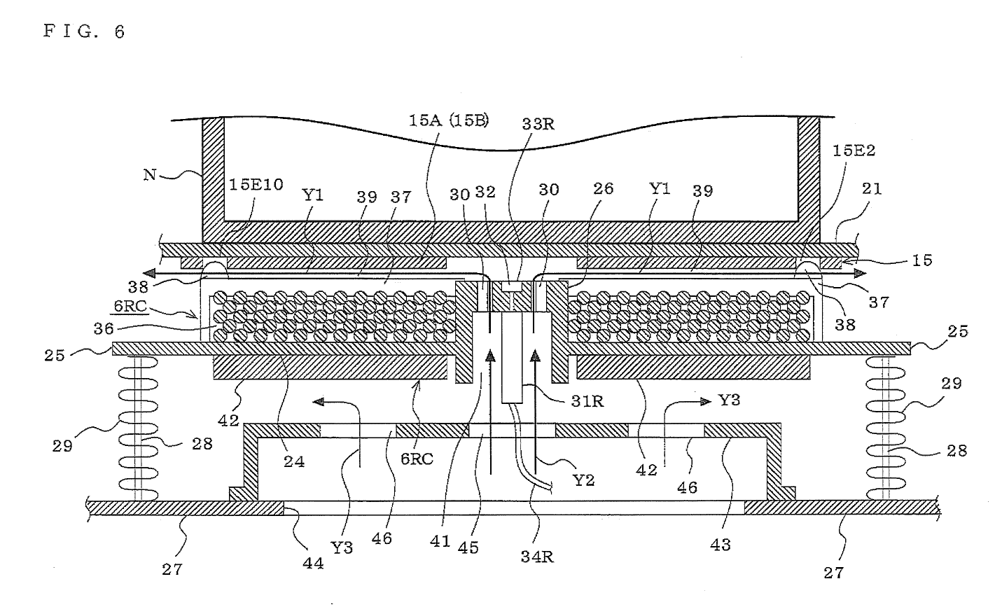

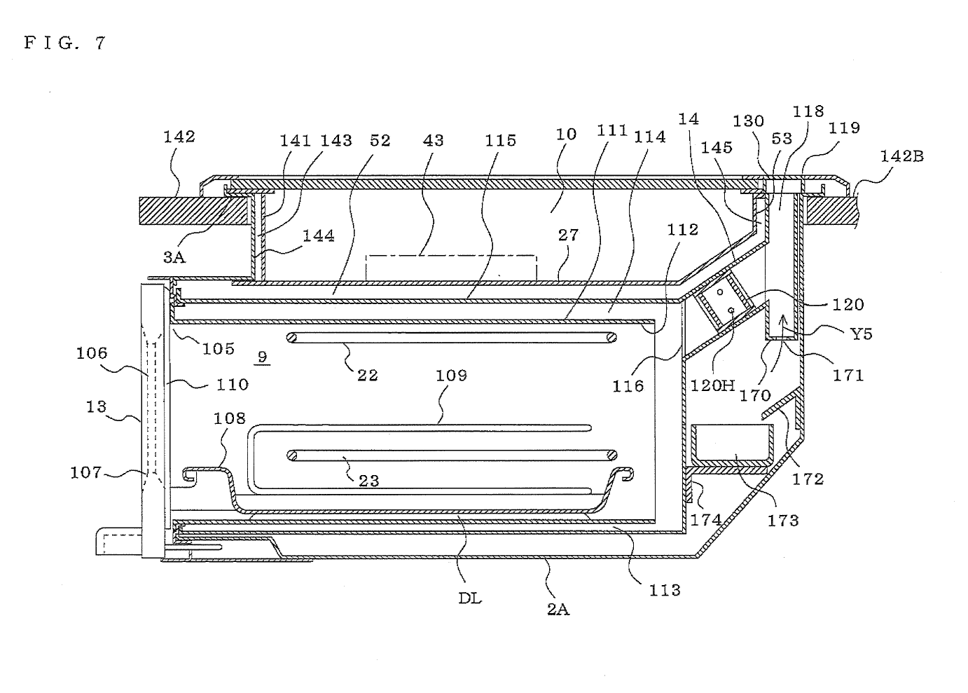

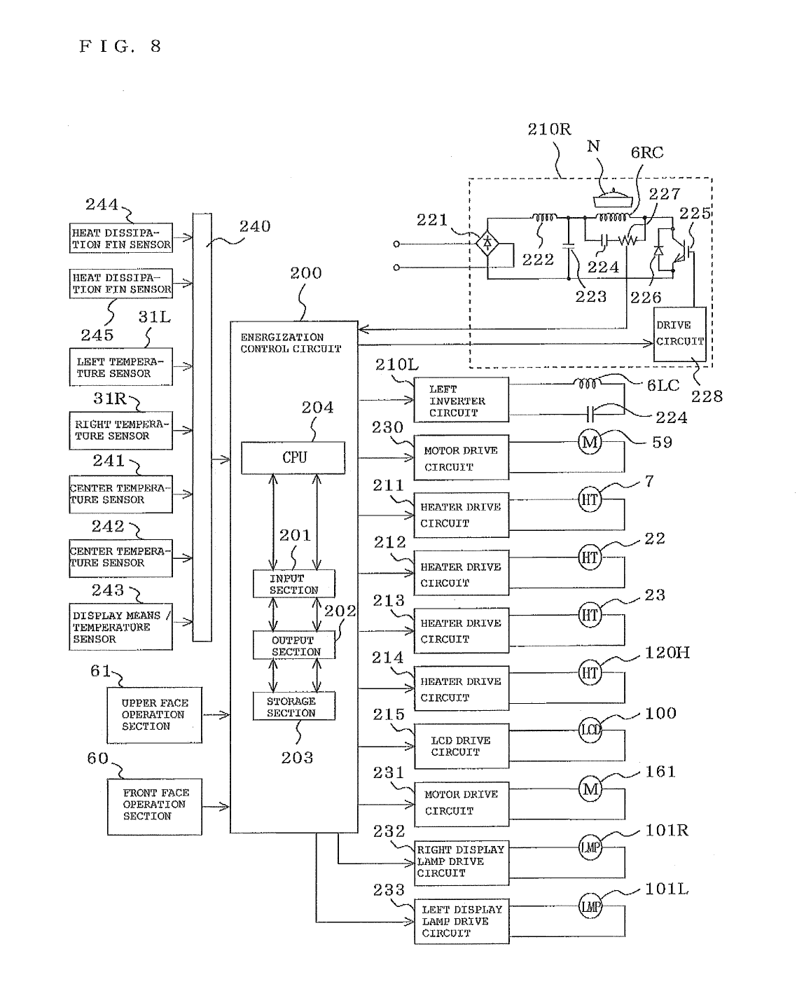

As a heat cooking device according to Embodiment 1, descriptions will be given to the heat cooking device r (an induction heat cooking device referred to as an embedded type of a built-in type) using an induction heating heater for heating means as an example. In addition, as for the heat cooking device, it is not limited to the induction heat cooking device, but such as an oven range and a jar rice cooker are applicable. FIG. 1 is an exploded perspective view showing a heat cooking device body according to Embodiment 1. FIG. 2 is a perspective view showing a top board and the entire body section according to Embodiment 1. FIG. 3 is a plain view partially viewing front of the body part according to Embodiment 1. FIG. 4 is a plain view of the entire body part according to Embodiment 1. FIG. 5 is a longitudinal sectional view at the right-half side position of the body section according to Embodiment 1. FIG. 6 is a longitudinal sectional view showing an induction heating coil section according to Embodiment 1. FIG. 7 is a longitudinal sectional view at the left-half side position of the body section according to Embodiment 1. And, FIG. 8 is a configuration diagram of a control circuit according to Embodiment 1. In addition, the same reference numbers have been repeated in each drawing to indicate the same or corresponding element.

(Heat Cooking Device Body)

A heat cooking device is provided with a rectangular body section A. The body section A is constituted by: a top board section B that is related to a body of the present invention and usually constituting an upper face of the body section A, a chassis section C constituting a periphery (an outer block) except the upper face of the body section A, heating means D that heats a pot and foods with electrical energy and the like, operation means E operated by the user, control means F that controls heating means upon reception of signals from the operation means, and display means G that displays operation conditions of the heating means. In addition, as part of the heating means D, electric heating means is provided referred to as a grill warehouse or a roaster.

Operation conditions of the heating means signify electrical and physical conditions for heating, being generically known as an energization time, an energization amount, a heating temperature, a energization pattern (continuous energization, intermittent energization, etc.).

To display signifies a behavior that visually informs the user of operation conditions and related information (including information for the purpose of alarming abnormal use and with the purpose of notifying occurrence of abnormal operation conditions, simply referred to as “cooking related information” hereinafter) helpful for cooking by such as characters, symbols, illustrations, colors, with or without light emitting, and changes in luminance.

Display means includes, unless otherwise specified, liquid crystal (LDC), a variety of light emitting elements (there are two types as an example of a semiconductor light emitting element: LED (Light Emitting Diode) and LD (Laser Diode), and organic-field light emission (Electro Luminescence: EL). Thus, the meaning of display means includes a display screen such as a liquid crystal screen and EL screen.

Information signifies an operation to inform the user for the purpose of making the user recognize operation conditions of control means and cooking related information by a display, a buzzer, or electronic voices (referred to electronically prepared or synthesized voices).

Information means includes information means by audible sounds from such as a buzzer and a speaker and information means by characters, symbols, illustrations, or visible lights.

In the body case 2, there are provided: a right IH heat source 6R and a left IH heat source 6L that generate electromagnetic energy for heating an object N to be heated such as a metal pot mounted on a top plate 21 to be mentioned later and a center heat source 7 that generates heat energy, control means F to be mentioned later that controls cooking conditions of the right IH heat source 6R, the left IH heat source 6L, and the center heat source 7, operation means E to be mentioned later that inputs the cooking conditions to the control means F, and display means G that displays information on operation conditions of the heating means input by the operation means E.

Detailed descriptions will be given to each as follows.

As shown in FIG. 1, inside the chassis section C, an electric component chamber 8, a roaster heating chamber 9, an upper component chamber 10, a suction chamber 11, an exhaust chamber 12 are largely classified to be partition-formed. In addition, each room is not necessarily completely isolated from each other. For example, the electric component chamber 8 is communicated with the suction chamber 11 and the exhaust chamber 12.

The roaster heating chamber 9 is almost an independent enclosed space with the door 13 to be mentioned later being closed. However, it communicates with an external space of the chassis section C, that is, an indoor space such as a kitchen, through an exhaust duct 14.

(Top Board Section B)

As shown in FIG. 2, the top board section B is constituted by two large components, an upper frame 20 and a top plate 21.

The upper frame 20 is formed into a frame-shape totally from a metal plate such as a non-magnetic stainless plate or an aluminum plate, having a size closing an upper face opening 2SP of the body case 2.

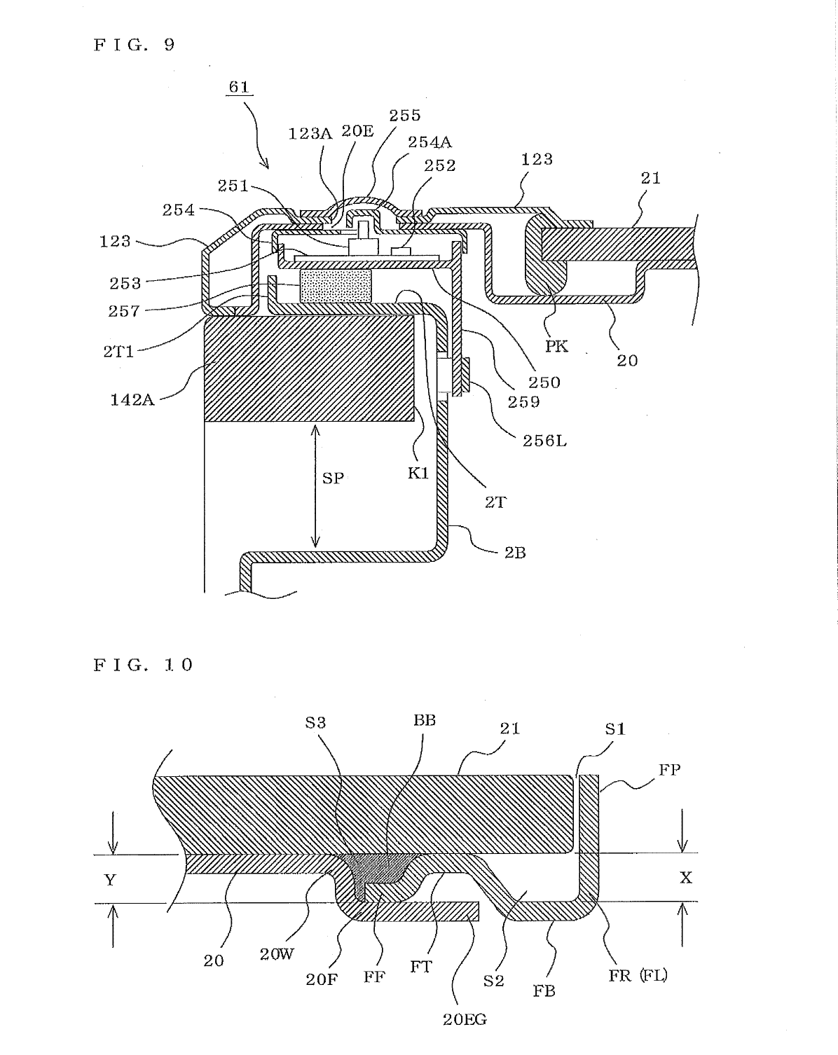

The top plate 21 is superposed and arranged so as to cover a large opening 20A provided at the center of the upper frame 20. The top plate 21 is totally constituted by a translucent material such as heat-resistant tempered glass and crystallized glass that transmits an infrared ray, being formed into a rectangular or square shape conforming to the shape of the opening 20A of the upper frame 20. Further, the top plate 21 is fixed into a watertight condition by interposing a rubber packing and sealing material PK between the opening 20A of the upper frame 20 and the upper face as shown in FIGS. 9 and 10. Accordingly, water droplets are prevented from entering into the inside of the body section A through a gap between the upper frame 20 and the top plate 21 from the upper face of the top plate 21.

Again in FIG. 2, on the upper face of the top plate 21, a circular guidance marks, 6MR, 6LM, and 7M are displayed that shows rough positions of a right IH heat source 6R, a left IH heat source 6L, and a center heat source 7 to be mentioned later by a method such as printing, respectively.

(Heating Means D)

As shown in FIGS. 1 and 2, the heat cooking device according to Embodiment 1 is provided with a right IH heat source 6R arranged at an upper right side position of the body section A, a left IH heat source 6L arranged at an upper left side position of the body section A, a center heat source 7 arranged back to an upper center of the body section A, and heaters 22 and 23 (refer to FIG. 7) that are upper and lower radiation-type electric heat sources for the roaster as heating means D. These heat sources are configured such that control means F independently controls each energization. Details of control will be described later.

(Right IH Heat Source 6R)

As shown in FIGS. 1 and 2, the right IH heat source 6R is installed in an upper component chamber 10 that is partition-formed in the body case 2. A right IH heat coil 6RC is arranged at lower face side of the right side position of the top plate 21. The upper end of the right IH heat coil 6RC comes close to the lower face of the top plate 21 with a minute gap to be an electromagnetic induction heat source. In Embodiment 1, for example, the heat source whose maximum power dissipation (maximum heating power) exceeds 3 kW is employed.

30 thin wires of about 0.1 mm are spirally bundled. One or a plurality of the bundle is wound while being twisted to have a circular outer shape. Finally the right IH heat coil 6RC is formed into a disc shape. The diameter (maximum outer diameter dimension) of the right IH heat coil 6RC is approximately 180 mm. In addition, the configuration is not limited to the above. For example, by spirally bundling 19 thin wires of about 0.3 mm and winding two or four resulting bundle while twisting, the right IH heat source 6R may be configured.

The position of a guidance mark 6RM, which is a circle (a broken line in FIG. 2) represented on the top plate 21, denotes a proper induction heating area.

The right IH heating coil 6RC may be divided into a plurality of sections so as to be independently energized. The object N to be heated may be heated by three energization patterns of inside IH heating coil energization, outside IH heating coil energization, and both inside and outside IH heating coils energization by spirally winding an IH heating coil inside and placing another large-diameter spiral IH heating coil wound spirally at an outer circumference of the inside IH heating coil on the concentric circle thereof and almost on the same plane. By matching one of or a combination of an output level, a duty ratio, an output time interval of high-frequency power given to the two IH heating coils, the pot from small-type to large-type (large dimensions) may be efficiently heated. (As a typical technique using a plurality of coils that can be independently energized, Japanese Patent No. 2978069 is known.)

Reference number 30 denotes a ventilation hole formed on a ceiling face of a circular protrusion 26 at regular intervals in the plural. Reference number 31R denotes an infrared type temperature detection element installed inside the protrusion 26. The temperature detection element 31R makes a light receiving section 33R to be oriented to right above position of an opening 32 formed at the center position on the ceiling face of the protrusion 26. Reference number 34R denotes a lead wire of the temperature detection element 31R. (Refer to FIG. 6)

The infrared type temperature detection element 31R (hereinafter referred to as “infrared sensor”) is constituted by such as a photo diode capable of measuring temperature by detecting an amount of infrared rays emitted from the object N to be heated like a pot. The temperature detection element 31R may be a heat-transfer type detection element, for example, a thermistor-type temperature sensor.

When installing the infrared type temperature sensor as shown in FIG. 6, the temperature of the object N to be heated can be detected at the position corresponding to the bottom center thereof. According to the Stefan-Boltzmann law, an infrared ray energy emitted from the object N to be heated is proportional to a fourth power of the absolute temperature thereof. The higher the temperature, the more the emitted infrared ray energy increases at an accelerated pace. The infrared ray sensor receives the emitted infrared ray to utilize a voltage in proportion to the energy of the ray as an output.

When actually using the infrared ray sensor, a band pass filter (band filter) that makes only a wavelength in a predetermined band in order to cut the infrared ray emitted from the top plate 21 downward of the object N to be heated is arranged in front of the infrared ray receiving section (light receiving section 33R) so that the infrared ray from the object N to be heated is effectively captured. Even so, since the received energy is weak, ways and means are figured out such that by amplifying the received ray energy with amplifying means (amplifier), an output voltage according to the amount of the infrared ray energy can be obtained.

The infrared ray sensor can rapidly detect the infrared ray emitted according to the temperature from the object N to be heated from downward of the top plate 21. It is well known in, for example, Japanese Unexamined Patent Application Publication No. 2004-953144 (Japanese Patent No. 3975865), Japanese Unexamined Patent Application Publication No. 2006-310115, and Japanese Unexamined Patent Application Publication No. 2007-18787.

The infrared ray type temperature detection element 31R is superior (to thermistor type) because emitted infrared rays from the object N to be heated are collected are received on a real-time basis (with almost no time lag) and temperature can be detected based on the amount of the infrared ray. The infrared ray sensor can detect the temperature of the object N to be heated even when the temperature of the top plate 21 made of such as heat-resistant glass and ceramics in front of thereof is not equal to the temperature thereof or independent of the temperature of the top plate 21. That is because ways and means are figured out such that the infrared rays emitted from the object N to be heated are not absorbed or interrupted by the top plate 21. For example, for the top plate 21a material is selected that transmits infrared rays of a wavelength region of 4.0 micron or 2.5 micron or less, while for the temperature detection element 31R materials that detects infrared rays of a wavelength region of 4.0 micron or 2.5 micron or less are selected.

On the other hand, in the case where the temperature detection element 31R is of a heat transmission type such as a thermistor, compared with the above-mentioned infrared ray sensor, an abrupt change in temperature cannot be captured on a real-time basis, however, the temperature of the top plate 21 can surly detected that is subjected to a radiation heat from the top plate 21 and the object N to be heated and is located at the bottom of the object N to be heated and right below thereof. In addition, when there is no object N to be heated, the temperature of the top plate 21 can be detected. In the case where the temperature detection element 31R is of a heat transmission type such as the thermistor, the temperature of the top plate 21 itself may be as precisely grasped as possible by making the light receiving section 33R to directly be in contact with the lower face of the top plate 21 or making a member such as heat-conductive resin to be interposed. Because a delay is generated in temperature transmission when there is a gap between the light receiving section 33R and the lower face of the top plate 21.

When the temperature detection element 31R detects the temperature of the top plate 21 and the object N to be heated, it is difficult to precisely detect only the inherent temperature to the object whose temperature is to be measured only by a calculation value (theoretical value) in any of a heat transmission type such as a thermistor or an infrared type. Therefore, the temperature at the center of the bottom of the object N to be heated and the outer circumference temperature thereof are indirectly detected with a minute gap (with the object N to be heated), the difference is verified between the temperature indicated by the measurement data then and an actual temperature obtained from experimental results, and adjustments may be performed in advance so that detected temperatures of the temperature detection elements 31R and 31L comes close to the actual temperature of the top plate 21 and the object N to be heated.

The temperature detection elements 31R may be used for a sensor for judging whether the object N to be heated is placed on the top plate 21.

In FIG. 6, the reference number 41 denotes a cavity section formed downside of the protrusion 26. The cavity 41 secures a space in which a cooling air Y2 flows in the periphery of the temperature detection elements 31R.

The reference number 42 is a magnetic flux leakage prevention material attached to the lower face (rear face) of the right IH heating coil 6RC. The magnetic flux leakage prevention material 42 is composed of high permeability material, for example, ferrite. The magnetic flux leakage prevention material 42 does not have to cover the entire lower face of the right IH heating coil 6RC. The material 42 formed into a bar-shape whose cross section is, for example, a square and a rectangular, may be plurally provided with a predetermined interval so as to cross the right IH heating coil 6RC. That is, the material 42 may be radially provided in the plural with the center being the protrusion 26.

A reference number 43 denotes a duct. The duct 43 has a length (a horizontal width) extending both to the downward of the base 24 of the right IH heating coil 6RC and to the downward of the base (not shown) of the left IH heating coil 6LC. The duct 43 is installed on a partition board 27 as well. That is, the duct 43 has a length nearly of the entire lateral width of the upper component chamber 10.

A center ventilation hole 45 at the center and a plurality of ventilation holes 46 in the circumference are formed on the duct 43 corresponding to the opening 44 formed on the partition board 27 and the cooling air introduced from the opening 44 is distributed to a predetermined position of the right IH heating coil 6RC. A symbol Y3 denotes a cooling air (hereinafter referred to as “cooling air Y3”) passing through the ventilation hole 46 to flow the lower face of the right IH heating coil 6RC. In addition, the remaining cooling air introduced from the opening 44 into inside of the duct 43 to be blown out from the center ventilation hole 45 at the center and a plurality of ventilation holes 46 is blown out downward of the left IH heating coil 6LC to cool the base (not shown) of the left IH heating coil 6LC.

Thus, since a cooling air path 39 is radially formed centering around the protrusion 26 by a rib 37 integrally formed by a bonding agent 36 made of resin on the upper face of the right IH heating coil 6RC, the cooling air Y1 can be effectively flowed from the center against the cooling air path 39 formed by the rib 37 and protrusion 38. The cooling air Y1 allows the right IH heating coil 6RC to be cooled from upward to improve cooling efficiency of the right IH heating coil 6RC that becomes a high temperature during energization.

The cooling air Y3 can be flowed at the lower face of the right IH heating coil 6RC, it is possible to improve cooling efficiency of the right IH heating coil 6RC that becomes a high temperature during energization.

Further, since a heat-resistant thermosetting bonding agent 3 is flowed on the upper face of the right IH heating coil 6RC to form the rib 37 and the protrusion 38, the entire right IH heating coil 6RC is rigidly integrated to effectively maintain a predetermined circular shape.

(Left IH Heat Source 6L)

As shown in FIG. 1, the left IH heat source 6L is installed at a position in symmetry with the right IH heat source 6R interposing left and right centers of the body section A, having a similar configuration to the right IH heat source 6R. Therefore, a temperature detection element 31L installed in the protrusion 26, a light receiving section 33L made to be oriented to right above position of an opening 32 formed at the center position on the ceiling face of the protrusion 26, and a lead wire 34L of the temperature detection element are provided respectively corresponding to the right IH heat source 6R, however, detailed descriptions will be omitted. For the temperature detection element 31L, the same thing is used as the temperature detection element 31R.

In Embodiment 1, for the left IH heating coil 6LC, for example, the coil having an ability of maximum power dissipation (maximum heating power) 3 kW is used. The diameter (maximum outer diameter dimension) of the left IH heating coil 6LC is approximately 180 mm.

The position of a guidance mark 6LM, which is a circle (broken line in FIG. 2) displayed at a position corresponding to upward of the left IH heat source 6L on the top plate 21 shows an appropriate induction heating area.

In the following explanations, as for contents sharing members commonly arranged the right and left, descriptions will be sometimes abbreviated for “left and right” in the name and “L and R” in the symbol.

(Radiation Type Center Electrical Heat Source)

In FIGS. 1 and 2 again, the reference number 7 denotes a radiation type center electrical heat source (hereinafter, referred to as “center heat source 7”). The center heat source 7 is arranged almost on the center line of the top plate 21 in the body section A and at the position back to the top plate 21.

The center heat source 7 employs an electric heater (for example, a nichrome wire, a halogen heater, and a radiant heater) that performs heating by radiation. The object N to be heated such as a pot is heated from downward through the top plate 21. For example, the electric heater having an ability of the maximum power dissipation (maximum heating power) 1.2 kW is used.

The center heat source 7 is circular container shape whose entire upper face is open. As for a container-shaped cover 50 (refer to FIG. 5) made of a heat insulation material constituting the outermost circumference thereof, the maximum outer diameter dimension is approximately 180 mm and 5 mm in thickness.

With the top plate 21, a guidance mark 7M, which is a circle (broken line in FIG. 2) showing a position corresponding to an upward of the center heat source 7, is displayed by methods such as printing. The guidance mark 7M denotes a proper heating area.

(Radiation Type Electric Heat Source)

As shown in FIGS. 4 and 7, the partition board 27 has a size of partitioning the inside of the chassis section C into two spaces. An upper side component chamber 10 is upside of the partition board 27. An electric component chamber 8 is to the downward right side. The left side is a space 52 where a roster heating chamber 9 exists.

As shown in FIGS. 1 and 4, the upper and lower partition board 51 is located between the electric component chamber 8 and the roster heating chamber 9 to partition the both. The upper end of the upper and lower partition board 51 abuts on the lower face of the partition board 27. The lower end abuts on the internal bottom of the chassis section C.

The upper side component chamber 10, the suction chamber 11, the exhaust chamber 12 are partition-formed respectively, however, each chamber is not necessarily completely isolated (under air-tight conditions) from each other. For example, the electric component chamber 8 is communicated with the suction chamber 11 and exhaust chamber 12.

As shown in FIG. 7, a rectangular-box-shaped-formed roster heating chamber 9 is in the space 52. With the roster heating chamber 9, wall faces of the right and left, the upper and lower, and back face side are formed by a metal plate such as a stainless and a steel plates. A pair of upper and lower heaters 22 and 23 (seeds heater) as the radiation type electric heat sources are installed so as to be spread almost horizontally in the vicinity of the upper side ceiling and bottom section.

The two heaters 22 and 23 are adapted to be simultaneously or separately energized to perform roast cooking (for example, broiled fish), grilled cooking (for example, pizza and gratin), and oven cooking (for example, cakes and grilled vegetables) that cooks while setting atmospheric temperature in the roaster heating chamber. For example, for the heater 22 in the vicinity of the upper side ceiling, the heater of the maximum power dissipation (maximum heating power) 1,200 W is used. For the heater 23 in the vicinity of the bottom section, the heater of the maximum power dissipation (maximum heating power) 800 W is used.

In addition, the space 52 is communicated with the exhaust chamber 12. The air in the space 52 is adapted to be discharged outside of the body section A through the exhaust chamber 12.

As shown in FIG. 1, reference number 53 is a rear partition board provided at a rear section of the partition board 27 for forming another exhaustion chamber 12 different from the upper side component chamber 10. The rear section partition board 53 has a height to contact with the partition board 27 at the bottom end and with the top plate 21 at the upper end.

As shown in FIGS. 1 and 5, reference number 54 is a blower case provided at the right side rear section of the partition board 27 for forming another suction chamber 11 different from the upper side component chamber 10 and the electric component chamber 8. With the blower case 54, a root section of the duct 55, on which an inlet 55A is formed at the upper part, is connected.

As shown in FIGS. 1 and 5, reference number 56 is an outlet formed at the front side center of the blower case 54.

As shown in FIG. 5, the reference number 54A denotes a ceiling wall continuously horizontally extending from the blower case 54. The reference number 57 denotes a blower accommodated in the blower case 54. The blower 57 is provided with a fan section 58 and a motor 59.

In addition, a rear partition board 53 may be integrally formed by cutting and raising the partition board 27.

(Blower for Cooling)

The blower 57 according to Embodiment 1 may be any of what is called an axial flow type blower, a centrifugal type blower (typically, a sirocco fan), or a multi-blade type blower, or a turbo type blower. The blower in the present invention includes all the types of blowers unless otherwise specified.

As shown in FIG. 5, the blower 57 secures the partition board 59A onto the rotation axis of the motor 59 to employ a centrifugal type blower sirocco fan in which a wing section 57A is formed around the partition board 59A.

The wind from the blower 57 flows from right to left in the upper component chamber 10 as shown by the arrow Y4 in FIG. 4 finally to be sent out from the exhaust chamber 12 to outside of the body section A. (In addition, since fine air streams vary according to such as arrangements of built-in components, the arrow Y4 denotes a mainstream of the air stream.)

To cool an IH heating coil using a sirocco fan is known by Japanese Patent No. 3945485, for example. To cool the IH heating coil using a turbo axial fan and a multi blade fan is known by Japanese Unexamined Patent Application Publication No. 2007-184287, No. 2004-39263, and No. 2002-110329. An axial flow type blower, a centrifugal type blower, or a turbo type blower differs in characteristics from each other and generated air volume and noises (wind noises) are not the same even when driven by the same electric energy, therefore, more favorable method may be selectable according to environmental conditions for use.

As shown in FIG. 5, when using the centrifugal type blower, a portion near to the partition board 59A has the largest discharging ability (blowing out ability). Accordingly, when a left side implementation circuit board 150L of the left IH heat source 6L is located at the front of the partition board 59A, the circuit board is cooled by the strongest wind. However, in the case where oily smoke and dusts are contained in the air from an internal space such as a kitchen, it is necessary to pay attention to that they possibly attach and deposit on the surface of the components of the left side implementation circuit board 150L. Oily deposits piled on the left side implementation circuit board 150L through usage over years will lead to deterioration in electrical insulation of the circuit board by absorbing moisture.

(Operation Means E)

In FIGS. 1 and 2 again, operation means E of the heat cooking device in Embodiment 1 is constituted by the front face operation section 60 and the upper face operation section 61.

(Front Face Operation Section 60)

A front face operation frame 62 made of plastics is attached on the right side front face of the body case 2 and the front face of the front face operation frame 62 is the front face operation section 60. With the front face operation section 60, there are provided: an operation button 63A (refer to FIG. 1) of a main power source switch (not shown) that concurrently apply or cut off the power supply of the left IH heat source 6L, right IH heat source 6R, center heat source 7, and heaters 22 and 23 (refer to FIG. 7) of the roaster heating chamber 9; a right operation dial 64R that opens/closes the electrical connection of a control switch (not shown) that controls the energization of the right IH heat source 6R and its energization amount (heating power); a left operation dial 64L of the left control switch (not shown) that controls the energization and its energization amount (heating power) of the left IH heat source 6L as well; and a center operation dial 65 of the control switch (not shown) that controls the energization and its energization amount (heating power) of the center heat source 7.

With the front face operation section 60, there are provided: a left indication light 66L that turns on only under the condition in which the left IH heat source 6L is energized by the left operation dial 64L, and a right indication light 66R that turns on only under the condition in which the right IH heat source 6R is energized by the right operation dial 64R.

As shown in FIG. 1, the left operation dial 64L, the right operation dial 64R, and the center operation dial 65 are pushed inside so as not to protrude from a front surface of the front face operation section 60 when not in use. Once the user pushes the dial for use with a finger and leaves the finger, the dial protrudes due to a force of the spring (not shown) built-in the front face operation frame 62 to be a rotatable state for the user by holding the circumference. Here, the left operation dial 64L, the right operation dial 64R, and the center operation dial 65 become a heating input waiting state with each being protruded from front surface of the front face operation section 60. Upon the rotation of each operation dial, energization of the left IH heat source 6L, the right IH heat source 6R, and the center heat source 7 is started.

Therefore, when turning any of the left operation dial 64L, the right operation dial 64R, and the center operation dial 65 to right or left, it is adapted that the control means F reads a predetermined electrical pulse generated by a built-in rotary encoder (not shown) according to the amount of rotation to determine the energization amount of the relevant heat source, enabling the heating power to be set. In addition, regardless of being under an initial condition or under the condition of being turned to right or left on the way, when any of the left operation dial 64L, the right operation dial 64R, and the center operation dial 65 is pressed by the user with a finger to such a predetermined location as not to protrude from front surface of the front face operation section 60, the energization can be stopped of any of the left IH heat source 6L, the right IH heat source 6R, and the center heat source 7. (Even during cooking, pushing the right operation dial 64R causes the right IH heat source 6R to stop energization right away.)

Closing operation (OFF) of the operation button 63A (refer to FIG. 1) of the main power supply switch causes operations of the right operation dial 64R and the left operation dial 64L to be ineffective all together thereafter. Similarly, energization is totally cut off for the center heat source 7 and the built-in heaters 22 and 23 in the roaster heating chamber 9.

Three independent timer dials 66, 67, and 68 are provided on the front face lower section of the front face operation frame 62. These timer dials 66, 67, and 68 are intended to operate a timer switch (not shown) to energize each left IH heat source 6L, right IH heat source 6R, and center heat source 7 for a desired time (timer setting time) from start of energization to automatically turn of the power supply after the elapse of the setting time.

(Upper Face Operation Section 61)

As shown in FIGS. 2 and 3, the upper face operation section 61 is constituted by the right heating power setting operation section 70, the left heating power setting operation section 71, and the center operation section 72.

The upper face operation section 61 is arranged on the upper face of the top plate 21, specifically at the front of the upper frame 20. With the center line (CL in FIG. 3) of the body section A being the center, the right heating power setting operation section 70 of the right IH heat source 6R is arranged to the right side, the center operation section 72 of the heaters 22 and 23 installed in the center heat source 7 and roaster heat chamber 9 at the center section, and the left heating power setting operation section 71 of the left IH heat source 6L to the left side, respectively.

(Right Heating Power Setting Operation Section 70)

In FIG. 3, a right one-touch key section 73 that can simply set the heating power of the right IH heat source 6R for the user to press once is provided at the right heating power setting operation section 70 for setting the heating power of the right IH heat source 6R.

The right one-touch key section 73 includes three one-touch keys, a weak heating power key 74, a medium heating power key 75, and a strong heating power key 76. For example, the weak heating power key 74 sets the heating power of the right IH heat source 6R at 300 W, the medium heating power key 75 at 750 W, and the strong heating power key 76 at 2.5 kW. In addition, a 3 kW key 77 is provided at the right edge section of the right one-touch key section 73. When the heating power of the right IH heat source 6R needs to be strong (3 kW, for example), it is pressed.

(Left Heating Power Setting Operation Section 71)

In FIG. 3, a left one-touch key section 82 that can simply set the heating power of the left IH heat source 6L for the user to press once is provided at the left heating power setting operation section 71 for setting the heating power of the left IH heat source 6L.

The left one-touch key section 82 includes three one-touch keys, a weak heating power key 78, a medium heating power key 79, and a strong heating power key 80. For example, the weak heating power key 78 sets the heating power of the left IH heat source 6L at 300 W, the medium heating power key 79 at 750 W, and the strong heating power key 80 at 2.5 kW. In addition, a 3 kW key 81 is provided at the right edge section of the right one-touch key section 82. When the heating power of the left IH heat source 6L needs to be strong (3 kW, for example), it is pressed.

In addition, not limited to 3 kW but any heating power (2.5 kW, for example) may be set by the 3 kW key 81.

(Center Operation Section 72)

As shown in FIG. 3, in the center operation section 72 an operation button 90 of an operation switch (not shown) that starts energization of the heaters 22 and 23 of the roaster heating chamber 9 used for roast cooking, oven cooking, and grill cooking and an operation button 91 that stops the energization are arranged to be provided.

At the center operation section 72, operation buttons 92 and 93 of a temperature adjustment switch (not shown) are provided side by side that sets the control temperature in the grill cooking by the heaters 22 and 23 of the roaster heating chamber 9 and in the electromagnetic cooking by the left IH heat source 6L and right IH heat source 6R by one degree each in an additive or a subtractive fashion. Further, a switch button 94 is provided that turns on or off the power source of the center heat source 7.

In FIG. 2, reference number 97R denotes a start switch (hereinafter referred to as “right timer switch 97R”) that operates/starts a timer counter (not shown). It is provided at the right edge section of the upper face operation section 61. When pressed once by the user and started, the time is measured from that time point and elapsed time information is displayed in units of “minutes” and “seconds” in the right liquid crystal display section 98R (located in the vicinity of the lower part of the top plate 21, upward of the top plate 21) installed at the right front corner section of the top plate 21 by transmitting a display light.

The lock key switch 83 is provided at the front side of the right timer switch 97R to make the operation of energizising the heating means D (the right IH heat source 6R, the left IH heat source 6L, and the center heat source 7) disable for preventing mischief by children, and information is displayed that a lock function is acting by the integrated display means 100 while the lock function is in operation.

The right fried foods selection switch 99R is provided at the right edge section of the upper face operation section 61. When the user presses it once, oil temperature in a fried foods (tempura) pot by the right IH heat source 6R can be set at 180 degrees as an initial setting. Thereafter, the user can adjust the heating power of the right IH heat source 6R by manipulating the right operation dial 64R to set the fried foods at an arbitrary suitable temperature, for example 200 degrees.

Every time the right fried foods selection switch 99R is pressed, setting is cyclicly changed such that normal fried foods mode→small amount of fried foods mode→cancellation of fried foods mode→normal fried foods mode. A buzzer (not shown) releases a predetermined buzzer sound to inform that the fried foods mode is changed. Here, the normal fried foods mode denotes a case where the amount of oil used for fried foods cooking is about 500 to 800 g, for example. The small amount of fried foods mode about 200 to 500 g. The user presses the right fried foods selection switch 99R to select the mode when starting the fried foods cooking.

At the time of cooking fried foods, in the right liquid crystal display section 98R, information on a target temperature (180 degrees, for example) for the fried foods cooking is displayed in units of “degrees”. When selecting the small amount of fried foods mode, a small amount of fried foods mode lamp (not shown) is turned on to inform in the vicinity to the left of the right liquid crystal display section 98R.

In the left heating power setting operation section 71, like the right heating power setting operation section 70, there are provided three, a left timer switch (not shown), a left liquid crystal display section 98L, and a left fried foods selection switch (not shown). These left timer switch and right timer switch 97R, left liquid crystal display section 98L and right liquid crystal display section 98R, and left fried foods selection switch and right fried foods selection switch 99R are symmetrically provided with the center line CL (refer to FIG. 3) of the body section A between them.

(Display Means G)

As display means G of the heat cooking device of Embodiment 1, integrated display means 100, heating power display lamps 101R and 101L, liquid crystal display sections 98R and 98L, and the like are provided.

(Integrated Display Means)

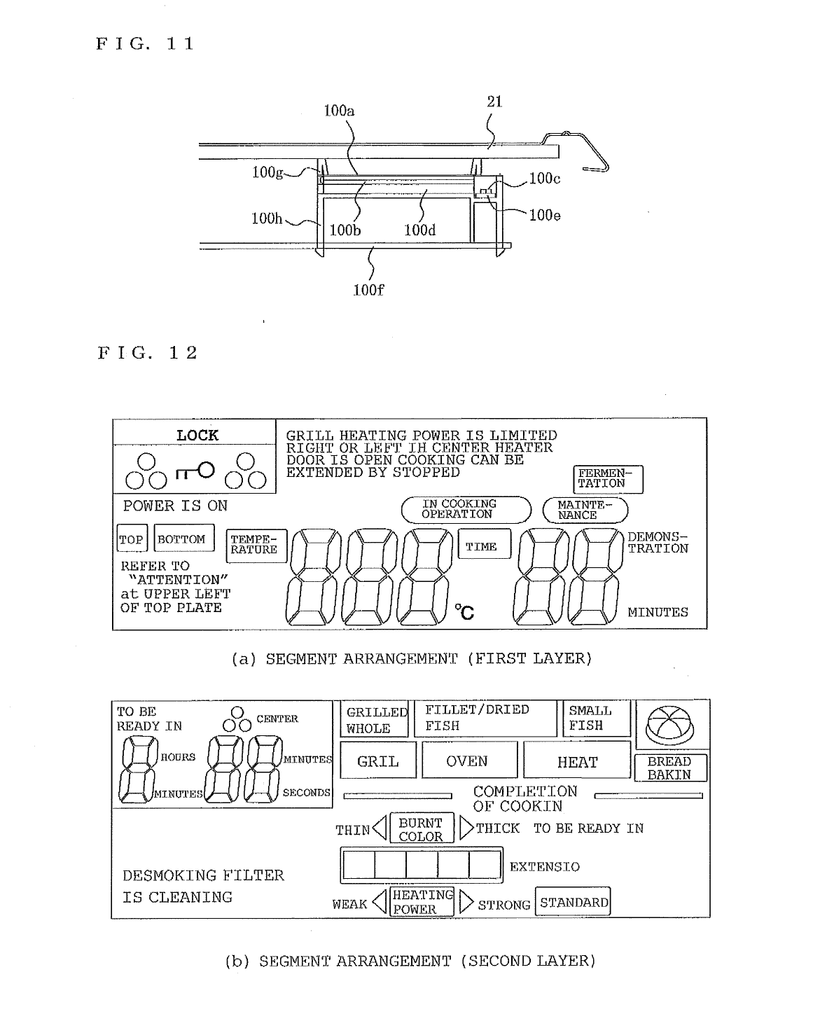

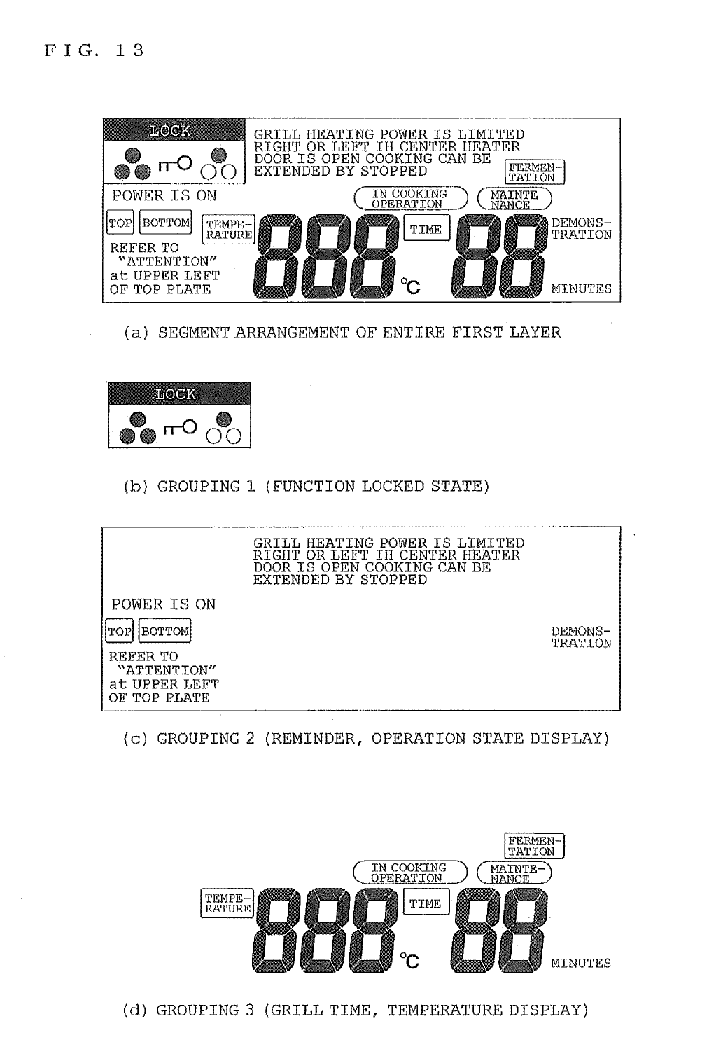

As shown in FIGS. 2 and 3, the integrated display means 100 is provided at the center section in the horizontal direction of the top plate 21 at the front side in the longitudinal direction. The integrated display means 100 corresponds to information means according to the present invention. As shown in FIG. 11, the integrated display means 100 includes a liquid crystal panel in which two layers of display face of information such as operation information, setting information, or operation condition information of the heating cooker input by operation means E are superimposed, and provided in the vicinity of the lower face of the top plate 21 so that the light from the backlight thereof is emitted to the upper face side through (to be made to penetrate) the top plate 21. With the liquid crystal panel, a first layer liquid crystal panel 100a and a second layer liquid crystal panel 100b are interposed by the glass plate respectively. The light emitted by the LED 100c is diffused by the light guide board 100d. The diffused light becomes a backlight to pass through the liquid crystal panels 100b and 100a, further to penetrate the top plate 21. Numerical numbers 100e and 100f denote a substrate that supplies electric power to the LED 100c and supplies signals to apply a voltage to drive a segment arranged on the liquid crystal panels 100a and 100b. Reference number 100g denotes a display frame that secures a gap having a predetermined height between the glass board located on the upper face of the liquid crystal panel 100a and the top plate 21 to prevent the heat of the top plate 21 from conducting to the liquid crystal panels 100a and 100b. Reference number 100h denotes a holder that supports the liquid crystal panel, LED 100c, light guide board 100d, and so on. The liquid crystal panels 100a and 100b correspond to the display device according to the present invention. As shown in FIG. 12, a plurality of segments is arranged in the liquid crystal panel of each layer. The segment to which a voltage is applied, which is an electrical signal from a drive circuit 215 to be mentioned later, blocks a backlight to display characters and figures on its display face. In Embodiment 1, the display face is constituted by two layers, however, three layers or more being allowable.

(Heating Power Display Lamp)

As shown in FIGS. 2 and 3, a right heating power display lamp 101R is provided that displays the magnitude of the heating power of the right IH heat source 6R at the position front right side of the top plate 21 between the right IH heat source 6R and right heating power setting operation section 70. The right heating power display lamp 101R is provided in the vicinity of the lower face of the top plate 21 so as to radiate a display light from the lower face to the upper face side through the top plate 21 (making the same to penetrate).

Similarly, the left heating power display lamp 101L that displays the magnitude of the heating power of the left IH heat source 6L is provided at the position of front left side of the top plate 21 between the left IH heat source 6L and the left heating power setting operation section 71. The left heating power display lamp 101L is provided in the vicinity of the lower face of the top plate 21 so as to radiate a display light from the lower face to the upper face side through the top plate 21 (making the same to penetrate). The heating power display lamp may be laid out in the vicinity of 70, 71, and 72 of the operation section 61 so as to effectively utilize the area of the top plate.

The right heating power display lamp 101R for the right IH heat source 6R is adapted to display, for example, from heating power 120 W to the maximum heating power 2.5 kW at eight stages as follows: heating power 1 (120 W), heating power 2 (300 W), heating power 3 (500 W), heating power 4 (750 W), heating power 5 (1000 W), heating power 6 (1500 W), heating power 7 (2000 W), and heating power (2500 W). In order to show these 8-stage heating power by two-color light emitting, eight light emitting sections are linearly arranged in the right heating power display lamp 101R and two light emitting diodes (blue and red, for example) are disposed, in which one light emitting section emits a light of different wavelength. For example, in the case of the heating power 1, the light emitting section corresponding only to the heating power 1 of the left side lights up in red, and seven light emitting sections of the right side from this light emitting section light up all in blue. The user of the heat cooking device can easily observe the red light from on the surface of the top plate 21.

At the left side of the light emitting section corresponding to the heating power 1, the light emitting section displaying a heat-retention mode is disposed. The light emitting section turns off the light during a non heat-retention mode. In the heat-retention mode, the light emitting section emits a light of a different color from red (orange, for example) to turn off all the eight light emitting sections in the right side. Therefore, the user easily observes them from on the surface of the top plate 21.

The left heating power display lamp 101L for the left IH heat source 6L is the same as the right heating power display lamp 101R of the right IH heat source 6R. Descriptions will be omitted.

(Liquid Crystal Display Section)

The left liquid crystal display section 98L and the right liquid crystal display section 98R are disposed at positions almost related to the operation sections 70, 71, and 72 corresponding to each heat source like the integrated display means 100. Information of each heat source according to its operation is mainly displayed. For example, the right liquid crystal display section 98R displays fried foods temperature, timer time, and the like related to the operation of the right IH heat source 6R.

(Roaster Heating Chamber 9)

As shown in FIG. 7, the front face opening 105 of the roaster heating chamber 9 is covered by the door 13 in a free opening and closing fashion. The door 13 is held by a support mechanism (not shown) onto the roaster heating chamber 9 so as to be freely movable in the longitudinal direction. At the center opening 107 of the door 13, a window board 106 made of heat-resistive glass is installed so as to enable visual confirmation of the inside of the roaster heating chamber 9 from outside.

A front edge section of the tray 108 made of metal is connected with the door 13. In the case of performing oily cooking, a metal grill 109 is usually placed for use on the tray 108. Thereby, when pulling out the door 13 forwardly, the tray 108 (including the grill 109 when the grill 109 is thereon) is also pulled together to the front of the roaster heating chamber 9 accompanied with the pull-out action.

Since the tray 108 is usually supported on a pair of metal rails DL connected with the door 13 while enabling free attachment and detachment, the tray 108 can be taken out of the metal rail DL alone.

The shape of the grill 109 and the position and shape of the tray 108 are figured out for the tray 108 not to be able to be pulled out so that the tray 108 comes into contact with the lower heater 23 when trying to be pulled out forwardly. Thus, the roaster heating chamber 9 has a “both sides cooking function” that heats foods from up and down both sides by energizing heaters 22 and 23 while placing meat, fish, and other foods on the grill 109.

A temperature sensor (not shown) that detects the indoor temperature is provided in the roaster heating chamber 9 to allow cooking while keeping the indoor temperature at a desired temperature.

As shown in FIG. 7, the roaster heating chamber 9 is constituted by a metal inner frame 111 having an opening 112 at the backward (rear face) side and a front face opening 105 at the front side, and an outer frame 115 covering the whole outside of the inner frame 111 while keeping a predetermined (lower) gap 113, (upper) gap 114, and right and left both sides gap (not shown).

The outer frame 115 has five faces: right and left both sides wall face, an upper face, a bottom face, and a rear face, and is entirely made of a steel plate and the like. On the inside surface of the inner frame 111 and outer frame 115, a covering having a favorable cleanability such as enamel is formed or heat-resistant coating is formed.

Reference number 116 denotes an exhaust opening formed at upper section of the rear wall of the outer frame 115.

Reference number 14 denotes an exhaust duct integrally formed outside of the exhaust opening 116. The exhaust duct 14 has a square or a rectangular cross section. The exhaust duct 14 slants obliquely upward as approaching the downstream side, thereafter being vertically bended. Finally, the upper end section opening 118 is communicated up to the rear section exhaust outlet 119 formed on the upper frame 20.

Reference number 120 denotes a catalyst for deodorizing. The catalyst for deodorizing 120 is installed at the downstream side position of the exhaust outlet 116 in the exhaust duct 14. It is activated by being heated by the catalyst heater 120H to remove an odor component of the heat passing from the inside of the roaster heating chamber 9 through the exhaust duct 14.

Reference number 110 denotes an annular (square shape) packing that is attached across all circumference of inside of the door 13 and is composed of elastic heat-resistive rubber and metal. The tip of the packing 110 comes in contact with the circumference front face of the front face opening 105 of the roaster heating chamber 9 so as to prevent heat from leaking outside from between the roaster heating chamber 9 and the door 13.

(Exhaust Structure and Suction Structure)

The inlet 55A (refer to FIG. 5) at the upper section of the blower case 54 is adapted to introduce the external indoor air into the body section A through the cover 130 (refer to FIG. 2) where a communication hole is provided.

As shown in FIGS. 1, 2, and 7, the exhaust duct 14 is located in the exhaust chamber 12. In other words, on right and left both sides of the exhaust duct 14, the exhaust chamber 12 is secured that is communicated with the space 52 formed around the roaster heating chamber 9.

As shown in FIG. 1, reference number 140 denotes a pair of ventilation holes formed on the rear partition board 53. The ventilation hole 140 is formed at a portion separated by a predetermined distance from right and left both side positions. The inside of the upper component chamber 10 is communicated with the exhaust chamber 12 through the ventilation hole 140.

In FIG. 7, reference number 141 denotes a front partition board stood on the front end of the partition board 27. The front partition board 141 is installed at a position where the gap 143 of approximately several mm is formed for improving a thermal insulation property with the vertical wall 144 of the body case 2, and the upper end extends to the lower face of the upper frame 20.

Reference number 145 denotes a gap. The gap 145 is formed between the rear partition board 53 provided at the rear section of the partition board 27 for forming a different exhaust chamber 12 from the upper component chamber 10 and the exhaust duct 14, and formed by a gap of approximately several mm for improving thermal insulation properties like the gap 143.

As shown in FIG. 5, reference number 150R denotes a right side implementation circuit board in the electric component chamber 8. Electric and electronic components constituting the drive circuit of the right IH heat source 6R are mounted on the right side implementation circuit board 150R, and an inverter circuit and the like for induction heating is formed thereon. Reference number 150L denotes a left side implementation circuit board. Electric and electronic components constituting the drive circuit of the left IH heat source 6L are mounted on the left side implementation circuit board 150L, and an inverter circuit and the like for induction heating is formed thereon.

Here, on the right side implementation circuit board 150R and the left side implementation circuit board 150L where the inverter circuit and the like are formed, as shown in FIG. 8, there are mounted main circuit components required for induction heating such as a rectification circuit 221 connected with a 100 V or 200 V commercial power source, a coil 222 connected with a DC side output terminal of the rectification circuit 221, a smoothing capacitor 223, a resonance capacitor 224 connected with the coil 222 and the smoothing capacitor 223, and an IGBT 225 to be switching means connected with above components.

In FIG. 5, reference number 151R denotes an aluminum heat dissipation fin mounted on the right side implementation circuit board 150R. Reference number 151L denotes an aluminum heat dissipation fin mounted on the left side implementation circuit board 150L. With the heat dissipation fins 151R and 151L, an IGBT 225 is mounted in a heat conducting manner, which is the semiconductor switching means that produces heat accompanied by power control operation of induction heating. A blower 57 supplies cooling air for preventing lowering of efficiency caused by high-temperature heat from the IGBT 225.

In FIG. 5, the right side implementation circuit board 150R and the left side implementation circuit board 150L are installed to form upper and lower two stages and supported by a board support table (not shown) so as to interposed these boards in the horizontal direction of the paper. Thus, in the electric component chamber 8, there are formed an air path 154 surrounded by the board support table at right and left sides, whose ceiling face is formed by the left side implementation circuit board 150L itself, and extending along the vertical direction of the height H2, an air path 155 surrounded by the board support table at right and left sides, whose ceiling face is formed by the partition board 27 itself, and extending along the vertical direction of the height H1.

At the back of these independent air paths 154 and 155, an outlet 56 of a blower case 54 of the blower 57 is opposed, and cooling air from the blower 57 is adapted to be supplied to the two air paths 154 and 155.

The cooling air supplied by the blower 57 to the air paths 154 and 155 passes around various electric components and heat dissipation fins 151R and 151L implemented on the right side implementation circuit board 150R and the left side implementation circuit board 150L to cool them, being introduced to the opening 44 provided on the partition board 27, which is a ceiling face of the upper air path 155.

In some cases, the amount of heat generation of the right side implementation circuit board 150R is not same as that of the left side implementation circuit board 150L. For example, when the right IH heat source 6R is driven at the maximum heating power 3 kW and the left IH heat source 6L by the maximum heating power 2.5 kW, the right side implementation circuit board 150R has larger amount of heat generation, however, the blast amount of the blower can cope with the amount of heat generation at the maximum heating power.

In the case where the amount of heat generation is different between the right side implementation circuit board 150R and the left side implementation circuit board 150L, allocation of the blast amount of the cooling air may be adjusted from the blower 57 to the two air paths 154 and 155. As for a method of allocating the blast amount, for example, the position of the outlet 56 may be vertically changed against the air paths 154 and 155 to adjust the allocation of the blast amount. Alternatively, by vertically changing positions of the right side implementation circuit board 150R and the left side implementation circuit board 150L, the allocation of the blast amount can be adjusted.

The above descriptions suppose cases where a single blower 57 for cooling can cool both the right IH heating coil 6RC and left IH heating coil 6LC. However, when poor cooling ability is concerned for a single blower 57, it can be coped with by providing a plurality of blowers 57 for cooling. Further, when providing a plurality of blowers 57 for cooling, the same type blowers are not necessarily required. A combination of an axial stream blower and a centrifugal blower is allowable.

(Auxiliary Cooling Structure)

In FIG. 5, reference number 160 denotes an auxiliary cooling fan (an auxiliary blower). The auxiliary fan 160 adopts an axial stream type fan, being made to face a ventilation hole (not shown) provided on the partition board 27 and fixed thereon. The suction hole is exposed to downward space of the partition board 27. The auxiliary cooling fan 160 sucks cooling air output from the blower 57 coming out of the outlet side of the two air paths 154 and 155 to send it into the upper space of the partition board 27, that is, the front space of the upper component chamber 10. Thereby, electrical components are cooled such as a liquid crystal substrate of the integrated display means 100 in the front space of the upper component chamber 10. The auxiliary cooling fan 160 is driven by a motor drive circuit 231 (refer to FIG. 8).

Reference number 162 denotes a partition wall with a shape in which the inside of the front face operation frame 62 is inflated to the electric component chamber 8 side. In the internal space 163 partition-formed between the inner wall face of the partition wall 162 and the front face operation frame 62, various control switches (not shown) of the front face operation section 60 are accommodated.

Reference number 164 denotes a ventilation hole formed on the rear wall of the partition wall 162. Reference number 165 denotes a ventilation hole provided on the ceiling wall face of the partition wall 162. Part of the cooling air from the blower 57 enters from the ventilation hole 164 to be adapted to cool the internal space 163 to be discharged from the ventilation hole 165.

(Auxiliary Exhaust Structure)

As shown in FIG. 7, at the downstream side of the catalyst for deodorizing 120 of the exhaust duct 14, a bottom section 170 is formed with a shape of being dented downward by one stage.

Reference number 171 denotes an exhaust and ventilation hole formed at the center of the bottom section 170. When high-temperature exhaust from the roaster heating chamber 9 naturally rises along the exhaust duct 14 by difference in air pressure between inside and outside the chamber and is discharged, internal air in the body section A is attracted from the exhaust and ventilation hole 171 as shown by the arrow Y5. Thereby, the air in the surrounding space of the roaster heating chamber 9 can be gradually discharged from the upper end section opening 118 of the exhaust duct 14.

(Control Means F)

As shown in FIG. 8, control means F is formed by an energization control circuit 200 constituted by one or a plurality of built-in microcomputers.

The energization control circuit 200 is composed of an input section 201, an output section 202, a storage section 203, and an operation control section 204. A DC power source is supplied to the energization control circuit 200 through a constant voltage circuit (not shown). The energization control circuit 200 plays a primary role of control means to control all heat sources and display means G.

In FIG. 8, the inverter circuit 210R of the right IH heat source 6R is connected with a 100 V or 200 V commercial power source through the rectification circuit 221 (referred to as rectification bridge circuit as well).

In the same way, in parallel to the inverter circuit 210R of the right IH heat source 6R, the inverter circuit of left IH heat source 6L 210L is connected with the commercial power source through the rectification circuit 221 (not shown).

Reference number 211 denotes a heater drive circuit of the center heat source 7. Reference number 212 denotes a heater drive circuit that drives the heater 22 for heating inside the roaster heating chamber 9. Reference number 213 denotes a heater drive circuit that drives the heater 23 for heating inside the roaster heating chamber 9. Reference number 214 denotes a heater drive circuit that drives a catalyst heater 120H installed on the way of the exhaust duct 14. Reference number 215 denotes a drive circuit that drives a liquid crystal screen (liquid crystal panels 100a and 100b) of the integrated display means 100. Reference number 230 denotes a drive circuit of a motor 59 of the blower 57 for keeping the internal space of the body section A to be a constant temperature range. Reference number 231 denotes a motor drive circuit of a motor 161 of an auxiliary cooling fan 160 fixed onto the partition board 27. Reference number 232 denotes a drive circuit that drives on/off of the right display lamp 101R. Reference number 233 denotes a drive circuit that drives on/off of the left display lamp 101L.

In the energization control circuit 200, setting information is input from the front face operation section 60 and the upper face operation section 61.

The inverter circuit 210R of right IH heat source 6R is provided with the right IH heating coil 6RC (induction heating coil) shown in FIG. 6, the rectification circuit 221, whose input side is connected with a bus line of the commercial power source, the DC circuit constituted by the coil 222 and the smoothing capacitor 223 connected with the DC side output terminal, the resonance circuit constituted by a parallel circuit of the right IH heating coil 6RC whose one end is connected with a connection point of the coil 222 and the smoothing capacitor 223 and the resonance capacitor 224, and the IGBT 225, which is switching means, whose collector side is connected with the other terminal of the resonance circuit.

The emitter of the IGBT 225 is connected with a common connection point of the smoothing capacitor 223 and the rectification circuit 221. The free wheeling diode 226 is connected between the emitter and the collector of the IGBT 225 so that the anode of the diode becomes the emitter side of the IGBT.

Reference number 227 denotes a current detection sensor. The current detection sensor 227 detects the current flowing through a resonance circuit composed of a parallel circuit of the right IH heating coil 6RC and the resonance capacitor 224. A detection output of the current detection sensor 227 is supplied to the input section 201 of the energization control circuit 200. In the case where an improper pot is used for induction heating and where an insufficient or an excess current is detected having equal to or more than a predetermined difference compared with a normal current value due to some sort of accident, the IGBT 225 is controlled by the energization control circuit 200 through the drive circuit 228 and energization of the right IH heating coil 6RC is stopped instantaneously.

Likewise, since the inverter circuit 210L of left IH heat source 6L is the same circuit configuration as the right heat source circuit 206R, descriptions will be omitted. Reference number 6LC denotes a left IH heating coil and 224L a resonance capacitor.

The current detection sensor 227 is provided, not shown, in the inverter circuit 210L of the left IH heat source 6L as well. As for the current detection sensor 227, some methods are configured by employing a flow diverter that measures current using a resistor and a current transformer.

In the heat cooking device that heats an object N to be heated by an induction heating method like Embodiment 1, the electric power control circuit for flowing high-frequency electric power through the heating coils 6RC and 6LC is called, what is called, a resonance type inverter.

The configuration is such that a circuit in which the inductance of the heating coils 6RC and 6LC including the object N (metal object) to be heated and the resonance capacitor 224 are connected is subjected to on-off control at a drive frequency of about 20 to 40 KHz of the IGBT 225, which is a switching circuit element.

The resonance type inverter has a current resonance type which is said to be suitable for 200 V power supply and a voltage resonance type, which is said to be suitable for 100 V power supply.

The configuration of such a resonance type inverter circuit is divided into, what is called, a half bridge circuit and a full bridge circuit according to how to switch a switching destination of the heating coils 6RC and 6LC and the resonance capacitor 224 by a relay circuit.

When induction-heating the object N to be heated using the resonance type inverter circuit, in the case of a magnetic material like iron and magnetic stainless, the object N is easy to be heated because resistance (equivalent resistance) contributing the heating is large and electrical power is easy to be input. However, in the case of a non-magnetic material such as aluminum, the eddy current induced in the object N is hard to be turned into the joule heat because of small equivalent resistance. Therefore, it is known that such control is performed that if the material of the object N to be heated is judged to be a magnetic material, the inverter circuit configuration is changed into a half-bridge method. In the case of the object N to be heated using the magnetic material, it is changed into the full-bridge method. (For example, Japanese Unexamined Patent Application Publication No. 05-251172, Japanese Unexamined Patent Application Publication No. 09-185986, and Japanese Unexamined Patent Application Publication No. 2007-80751)

In the present embodiment, unless otherwise specified, the inverter circuits 210R and 210L may be configured by any of the half-bridge circuit and full-bridge circuit.

As mentioned above, when induction-heating the object N (metal object) to be heated through energization of the heating coils 6RC and 6LC, a current of frequency of about 20 to 40 KHz may be made to flow by on/off-controlling the IGBT 225, which is a switching circuit element, at a drive frequency of about 20 to 40 KHz in a circuit where the resonance capacitor 224 is connected in the case where the object N to be heated is a magnetic material such as iron.

(Temperature Detection Circuit)

In FIG. 8, reference numeral 240 denotes a temperature detection circuit. To the temperature detection circuit 240, temperature detection information is input from each temperature detection element as follows:

(1) the temperature detection element 31R provided at the center section of the right IH heating coil 6RC;

(2) the temperature detection element 31L provided at the center section of the left IH heating coil 6LC;

(3) the temperature detection element 241 provided in the vicinity of the electric heater of the center heat source 7;

(4) the temperature detection element 241 for detecting inside temperature in the roaster heating chamber 9;

(5) the temperature detection element 243 installed in the vicinity of the integrated display means 100;

(6) the temperature detection element 244 closely attached to the heat dissipation fin 151R in the electric component chamber 8; and

(7) the temperature detection element 245 closely attached to the heat dissipation fin 151L in the electric component chamber 8.

Two or more temperature detection elements mentioned above may be provided with an object for temperature detection. For example, the temperature detection element 31R of the right IH heat source 6R may be provided at a center section and at an outer periphery section so as to achieve more precise temperature control. The temperature detection element using a different principle may be used for configuration. For example, it is allowable that the temperature detection element at the center of the right IH heating coil 6RC uses an infrared ray method and the temperature detection element provided at the outer periphery portion uses a thermistor method.

The drive circuit 230 of the motor 59 of the blower operates the blower 57 according to temperature measurement conditions of the temperature detection circuit 240 for each temperature measurement portion not to become higher than a predetermined temperature to supply cooling air and cool each portion.

The motor drive circuit 231 of the motor 161 of the auxiliary cooling fan 160 is driven by such that the energization control circuit 200 judges a necessary operation condition (blast amount) based on temperature detection information from the temperature detection circuit 240 for the liquid crystal screen portion of the integrated display means 100 not to become higher than a predetermined temperature.

(Upper Face Operation Section Structure)

FIG. 9 is a longitudinal sectional view showing an end of an upper face operation section and a top board section according to Embodiment 1. FIG. 10 is a longitudinal sectional view showing an end of the top board section. As shown in these figures, the upper face operation section 61 is located upward of the flange 2T of the metal front section flange board 2B fixed on the front end section of the upper face opening 2SP of the body case 2.

The upper face operation section 61 includes the substrate case 250 made of resin, the pressure operation type switch 251 attached onto the upper face of the substrate case 250, the substrate 253 on which electronic component elements 252 are implemented, the press button case 254 provided so as to cover upside of the switch 251 to have the press button 254A, and the membrane sheet 255 whose outer periphery edge is adhesively applied on the front frame body 123 so as to cover upside of the press button case 254. Reference number 20E denotes a through hole formed on the upper frame 20, intended for threading the press button 254A.

The press button case 254 is attached to the frame of the substrate case 250 so as to cover the substrate 253.

Reference number 255A denotes an elastic press button support body. The press button 254A is supported onto the press button case 254 by the press button support piece 255A. That is, when the press button 254A is pressed down by the user, the button moves downward for a predetermined length of 1 mm to several mm to close the pressure operation type switch 251. When stopping pressing the press button 254A from the above state, the press button support piece 255A returns back to the original upward location through an elastic force stability of its own to open the pressure operation type switch 251.

(Operation of Heat Cooking Device)

Next, descriptions will be given to the outline of operation of the heat cooking device.

In the storage section 203 in the energization control circuit 200, a fundamental operation program is stored from power-on to the start of cooking.

Firstly, the power plug is connected with the 200 V commercial power supply. To press the operation button 63A (refer to FIG. 1) of the main power supply switch to start power activation.

Then, a predetermined power source voltage is supplied to the energization control circuit 200 through a constant voltage circuit (not shown) and the energization control circuit 200 is started.

Firstly, the energization control circuit 200 performs self-diagnosis by a control program of its own to perform pre-cooking abnormality monitoring processing.

The temperature detection circuit 240 reads temperature data from temperature detection elements 31R, 31L, 241, 242, 243, 244, and 245 provided at seven locations in total to transmit the temperature data to the energization control circuit 200.

As mentioned above, since data on such as circuit current, voltage, and temperature of a primary configuration part is collected in the energization control circuit 200, abnormality heating decision is performed as the pre-cooking abnormality monitoring control. For example, if the temperature around the liquid crystal substrate of the integrated display means 100 detected by the temperature detection element 243 is higher than a heat-resistant temperature (70 degree, for example) of the liquid crystal display substrate, it is judged to be an abnormal high temperature.

The current detection sensor 227 provided in the inverter circuit 210R of the right IH heat source 6R detects the current flowing in the resonance circuit composed of a parallel circuit of the right IH heating coil 6RC and the resonance capacitor 224 to supply the detection results to the input section 201 of the energization control circuit 200.

Similarly, the current detection sensor 227 provided in the inverter circuit 210L of the left IH heat source 6L detects the current flowing in the resonance circuit composed of a parallel circuit of the left IH heating coil 6LC and the resonance capacitor 224 to supply the detection results to the input section 201 of the energization control circuit 200.

The energization control circuit 200 compares current detection results of the resonance circuit input into the input section 201 with a normal current value of a decision standard data stored in the storage section 203 to judge to be some accidents and poor energization to be abnormal when an insufficient or an excess current is detected.

In the case where no abnormal decision by the above-mentioned self-diagnosis step, it is “completion of cooking start preparation”. Then, with no abnormality, the energization control circuit 200 preliminarily drives the drive circuit 230 that drives the motor 59 of the blower 57.

Further, the energization control circuit 200 preliminarily drives the motor drive circuit 231 that drives the motor 161 of the auxiliary cooling fan 160. Moreover, the motor drive circuit 231 drives the motor 161 at a predetermined rated current to start operation of the auxiliary cooling fan 160.

The energization control circuit 200 preliminarily drives the inverter circuit 210 of the right IH heat source 6R, the inverter circuit 210L of the left IH heat source 6L, and the drive circuit 215 of the integrated display means 100, respectively.

However, in the case of the abnormality decision, the energization control circuit 200 performs a predetermined abnormality processing to become a state incapable of starting cooking.

(Cooking Mode)

Next, operations will be explained on the transition to the cooking mode after completing the above pre-cooking abnormality monitoring processing using the right IH heat source 6R as an example.

Firstly, the user turns the right operation dial 64R of the front face operation section 60 to right or left (heating power is set according to the turned amount).

Into the energization control circuit 200, operation signals are input from the front face operation section 60. In the energization control circuit 200, operation signals of keys for various switch operations (such as operation switches of heating power keys 74, 75, and 76, right timer switch 97R) are input from the upper face operation section 61. Thereby, cooking conditions are set such as heating power level and heating time.

Next, the energization control circuit 200 drives the drive circuit 228 of the inverter circuit 210R based on the set cooking conditions to drive inverter circuit 210R of the right IH heat source 6R. A high-frequency current flows in the right IH heating coil 6RC when the drive circuit 228 applies a drive voltage to the gate of the IGBT 225.

Thereby, a high-frequency magnetic flux from the right IH heating coil 6RC causes the pot that is the object N to be heated to become high temperature to enter into electromagnetic induction heat cooking operation (cooking mode).

The energization control circuit 200 drives the drive circuit 215 of the integrated display means 100 to make the same display cooking information such as heating power and cooking time in the display area thereof.

(Electromagnetic Induction Heating/Heating Power Control)

A commercial power source is connected with the rectification circuit 221 of the inverter circuit 210R. From the commercial power source, a low-frequency AC current and voltage of 50 Hz or 60 Hz are supplied.

The rectification circuit 221 is a circuit that rectifies the AC current of the commercial power source into the DC current, configured by bridge-connecting two thyristors and two diodes, for example (specific configurations are described in FIG. 1 of Japanese Unexamined Patent Application Publication No. 01-246783, for example).

The smoothing capacitor 223 is a capacitor having a relatively large capacitance for removing ripple currents to smooth the pulsating current rectified by the rectification circuit 221.

The DC current obtained by the rectification circuit 221 and the smoothing capacitor 223 is input into the collector of the IGBT 225, which is the switching element. Drive signals from the drive circuit 228 is input to the base of the IGBT 225 to perform on-off control of the same. By combining the on-off control of the IGBT 225 and the resonance capacitor 224, a high-frequency current is generated in the right IH heating coil 6RC. Electromagnetic induction action caused by the high-frequency current generates an eddy current in the object N to be heated such as a pot mounted on the top plate 21 upward the right IH heating coil 6RC.

Thereby, the eddy current occurred in the object N to be heated turns into the joule heat to generate heat, enabling usage in cooking.

The drive circuit 228 includes an oscillation circuit (not shown). The drive signal generated by the oscillation circuit is supplied to the base of the IGBT 225 to perform on-off control of the IGBT 225. Adjustment of the oscillation frequencies and oscillation timings of the oscillation circuit of the drive circuit 228 regulates the energization ratio, energization timing, and current frequency of the right IH heating coil 6RC to make it possible to perform heating power control of the same.

As for the configuration allowing the oscillation circuit to be variable, difference in the oscillation frequency among ranges in the case of multi-ranges causes beat tones and the like, therefore, its solution is proposed in Japanese Unexamined Patent Application Publication No. 09-185985.

(Demand Control)

If there are multiple heating means (right IH heat source 6R, left IH heat source 6L, center heat source 7, and heaters 22 and 23) usable at the same time like the heat cooking device of Embodiment 1, the maximum configurable heating power of each heating means is required to be controlled so that the total input current does not exceed the current capacity restriction of the distribution board in the home when a plurality of heating means is simultaneously in use (excessive current causes the breaker of the distribution board to be shut off).

For example, when the total power capacity is maximum 4.8 kW, however, the left IH heat source 6L 3 kW and the right IH heat source 6R 2.5 kW, simultaneous setting of both heat sources at the maximum heating power results in 5.5 kW, causing to exceed the current capacity limit.

Accordingly, under the condition where the left IH heat source 6L is in operation with heating power of 3 kW, the energization control circuit 200 restricts the heating power setting range of the right IH heat source 6R not to exceed (total power capacity 4.8 kW)−(the left IH heat source 6L heating power 3 kW)=(1.8 kW).

Alternatively, upon setting the right IH heat source 6R at the heating power exceeding 1.8 kW, the energization control circuit 200 may control to automatically lower the heating power of the left IH heat source 6L.

The energization control circuit 200 may give a predetermined order of priority to each heating means to allocate the heating power of each heating means in order from heating means having a higher priority.

For example, in the case where the total power capacity is 4.8 kW and the maximum heating power of the left IH heat source 6L, the right IH heat source 6R, the center heat source 7, and the grill (heaters 22 and 23) is 3 kW, 2.5 kW, 1.5 kW, and 2 kW (total of the heater 22 and the heater 23) respectively, the order of priority of each heating means is given as a first, a second, a fourth, and a third, respectively. When the heating power of the left IH heat source 6L is set at 3 kW, the maximum heating power of the right IH heat source 6R becomes 1.8 kW. When the maximum 1.8 kW is set as the heating power of the right IH heat source 6R actually, the configurable heating power of the center heat source 7 and grill becomes 0 kW, respectively.

Under the above conditions, when setting the heating power of the left IH heat source 6L at 1 kW, the right IH heat source 6R can set the heating power up to 2.5 kW. However, even if the heating power of the right IH heat source 6R is set at 2.5 kW, the margin of 1.3 kW is available against the total power capacity limit 4.8 kW because total heating power is 3.5 kW. Therefore, the grill is allowed to set the heating power up to 1.3 kW and the maximum heating power allowed for the center heat source 7 is the difference between the heat power set for the grill and the maximum allowable heating power.

Set values of the right heating power setting operation section 70 of the upper face operation section 61, various switch operation keys (heating power keys 74, 75, and 76, operation switches to start energization of heaters 22 and 23 of the roaster heating chamber 9, for example) can be directly used for the heating values of each heating means. The heating power can be obtained as well by the current value detected by the current detection sensor 227 that detects the current flowing from each various switch operation key to the IH heating coil through the energization control circuit 200 and the drive circuit 228.

(Abnormality Monitoring During Cooking)

The heat cooking device of Embodiment 1 performs abnormality monitoring control during cooking as well.

The energization control circuit 200 judges that the detected current value by the current detection sensor 227 is an insufficient current or an excess current compared with a normal current value during cooking.

If the detected current value by the current detection sensor 227 is the insufficient current or the excess current, the energization control circuit 200 controls the IGBT 225 via the drive circuit 228 to stop energization of the right IH heating coil 6RC in an instant.

The portion where the temperature increases during cooking is considered to be two heat dissipation fins 151R and 151L installed inside the electric component chamber 8 and the integrated display means 100 located inside of the upper component chamber 10 as well as the temperature detection element 31R provided at the center of the right IH heating coil 6RC.

Thus, the energization control circuit 200 monitors the temperature data from the temperature detection element 31R, 31L, 241, 242, 243, 244, and 245 through the temperature detection circuit 240 to monitor whether an abnormal temperature might be detected.

For abnormality judged to be an abnormal temperature, the energization control circuit 200 performs a predetermined abnormality correction processing.

For example, upon judging that the right IH heat source 6R is at an abnormally high temperature, the energization control circuit 200 controls the drive circuit 230 of the motor 59 to increase the rotation speed of the blower 57 to increase the cooling air amount. With no effect of improvement for continuing the above for a predetermined time, the heating power (electric power) of the right IH heat source 6R is forcibly lowered (from the level set by the user). For example, it is lowered up to the maximum heating power among three: heating power below one step, heating power equal to or less than 300 W, and heating power of 10%. (When used by 3 kW heating power, it is lowered to 2.7 kW.)

When such an abnormality correction processing is performed, the energization control circuit 200 drives the drive circuit 215 of the integrated display means 100 to make it display preliminary announcement information that the heating power will be automatically lowered in a predetermined display area of the integrated display means 100.

In addition, configurations are not limited to the above, but when the energization control circuit 200 judges that the temperature of the right IH heat source 6R is abnormally high, the energization control circuit 200 may drive the drive circuit 215 of the integrated display means 100 to make it display error instead of display preliminary announcement information that the heating power will be automatically lowered in a predetermined display area of the integrated display means 100.

Then, the energization control circuit 200 judges again the presence or absence of abnormality whether the high-temperature abnormality state is resolved in a predetermined short time from the time when it is judged that abnormality occurred in the right IH heat source 6R. The energization control circuit 200 immediately stops energization of the right IH heat source 6R when the detection temperature of the temperature detection element 31R of the right IH heat source 6R becomes a predetermined temperature (for example, 300 degrees) or the detection temperature of the temperature detection element 243 of the liquid crystal display substrate of the integrated display means 100 becomes the predetermined temperature (for example, 70 degrees).

When an energization-interruption command of the right IH heat source 6R is issued, the energization of the right IH heat source 6R is suspended, however, the blower 57 for cooling that cools the right IH heating coil 6RC of the right IH heat source 6R continue operation for two to five minutes after the energization interruption. Thereby, an overshoot problem can be prevented in advance in which heat is retained in the circumference of the right IH heat source 6R just after the ventilation is stopped from the blower 57 for cooling, resulting in an abrupt temperature rise. Further, a harmful effect can be avoided in which the temperature of the integrated display means 100 becomes high.

The operation duration is decided by the energization control circuit 200 from a predetermined formula or a numerical table according to conditions such as the temperature rise behaviors until the energization interruption, indoor temperature, and magnitude of the heating power in operation of the heat source.

However, when the blower 57b itself is found to be faulty such that an abnormal current is detected from the blower 57 for cooling (for example, the temperature of the heat dissipation fin 151R alone rises), energization of the blower 57 for cooling is interrupted simultaneously.

While the blower 57 for cooling is in operation, the auxiliary cooling fan 160 is operated. When the blower 57 for cooling is suspended abnormally, the auxiliary cooling fan 160 continues operation because it serves to supply cold air to the integrated display means 100.

The liquid crystal display substrate of the integrated display means 100 is heated by reflected heat from the bottom of the heated object N to be heated and radiation heat from the top plate 21 during heat cooking by the right IH heat source 6R and the left IH heat source 6L. It is subjected to heat of a high-temperature pot (nearly 200 degrees) placed at the center of the top plate 21 left thereon that is just used for cooking tempura.

Therefore, in Embodiment 1, in order to suppress temperature rise of the integrated display means 100, the auxiliary cooling fan 160 performs air-cooling from right side.

(Operation of Integrated Display Means)

Next, detailed descriptions will be given to the display of the integrated display means 100, which is information means according to the present invention.

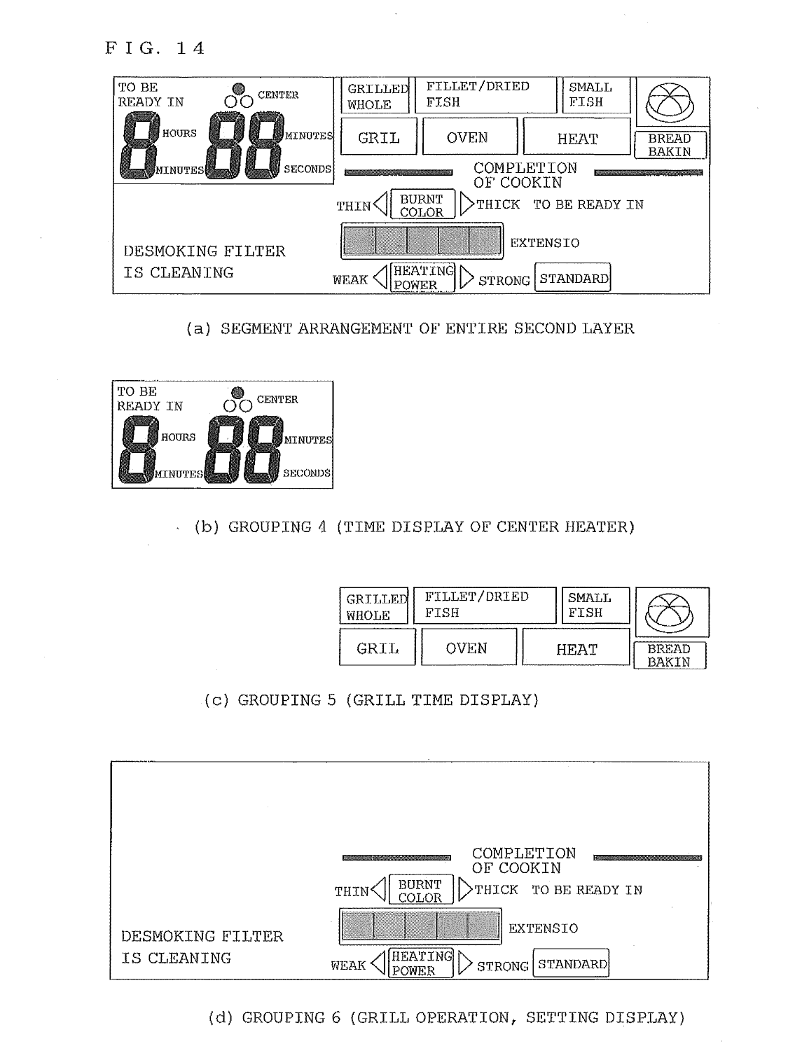

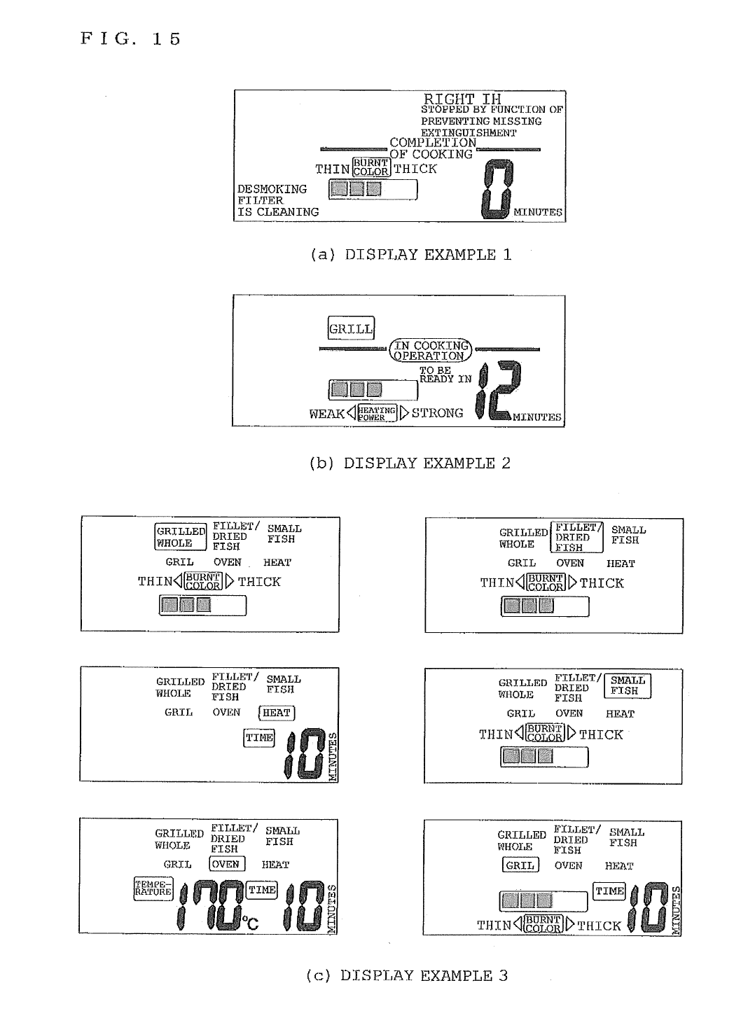

FIG. 11 is a sectional view of comprehensive display means according to Embodiment 1. FIG. 12 is a segment arrangement drawing of comprehensive display means according to Embodiment 1. FIG. 13 is a drawing illustrating a display face of a first layer of comprehensive display means according to Embodiment 1. FIG. 14 is a drawing illustrating a display face of a second layer of comprehensive display means according to Embodiment 1. FIG. 15 is a drawing illustrating a display example in the case of driving a first and a second segments of comprehensive display means according to Embodiment 1.

The integrated display means 100 displays information on operation states (heating power, heating time, and so on) of the left IH heat source 6L, the right IH heat source 6R, the center heat source 7, and heaters 22 and 23 of the roaster heating chamber 9 and the like and setting information input from the operation means E.

That is, in response to situations as follows, information on operation conditions and heating conditions such as heating power are displayed by characters, illustrations, and graphs:

(1) functions of the right IH heat source 6R and the left IH heat source 6L (whether an appropriate heating operation or not, etc.),

(2) functions of the center heat source 7 (whether in cooking or not, etc.),

(3) in the case of the cooking in the roaster heating chamber 9, operation procedure and functions to perform the heat cooking (for example, what is being done now in the cooking of the roaster, grill, and oven), and

(4) display of reminder and display of operation conditions in the entire cooking equipment.

The liquid crystal screen used by the integrated display means 100 employs segment liquid crystal. When displaying a character, a single segment can display a number of characters. A larger character could be displayed by the number of segments equivalent to a single layer liquid crystal.

FIG. 13(a) is a display at the time of entirely driving a first layer segment of the integrated display means 100. There are: a segment (refer to FIG. 13 (b)) grouped into a function lock state display such as the state display of child lock mode that disables operation keys of the whole heat cooking device and the state display of radiant heater lock mode that independently disables functions so as not to be burnt by mischief because the center heat source 7 is a radiation type heater; the segment (refer to FIG. 13 (c)) grouped into reminder/operation state display such as state display of equipment or display of reminder to the user by combining each segment such as “grill”+“door is open” and “left”+“IH”+“by a function preventing missing extinguishment”+“suspended”; and the segment (refer to FIG. 13 (d)) grouped into grill time/temperature display such as set temperature of the oven mode while the grill is in operation and setting display such as “temperature”+“170 degrees” and “time”+“20”+“minute”. Some segment grouped into reminder/operation state display has a segment that displays “demo” at the demonstration mode that only validate display and operation while the heat source is not energized at the display state of merchandises.

FIG. 14(a) is the display in which all the second layer segment of the integrated display means 100 are made to drive. There are a segment (refer to FIG. 14 (b)) grouped into the time display of the center heater, the segment (refer to FIG. 14 (c)) grouped into the grill menu display, and the segment (refer to FIG. 14 (d)) grouped into the grill operation/setting display.

(Example of Display of Integrated Display Means)

Examples will be shown in which a first layer segment and a second layer segment are driven simultaneously.

The operation conditions of the right IH heat source 6R (stops by right IH missing extinguishment function), a timer time, and “Desmoking filter is cleaning” at the maintenance mode in which catalyst 120 for deodorizing of the exhaust duct 14 communicating with the roaster heating chamber 9 is cleaned after the completion of grill cooking, are displayed. (Refer to FIG. 15 (a)) Here, for part of the segment grouped into reminder/operation state display (“right”, “IH”, “stopped by the preventing missing extinguishment function”) and part of the segment grouped into grill time/temperature display (segment of grill time display) of the first layer segment, and part of the segment grouped into grill time/temperature display of the second layer segment (“Desmoking filter is cleaning”, “cooking completed”, “burnt color” and so on), segments of the both layers are displayed simultaneously without overlapping.

Another example will be shown in which the first layer segment and the second layer segment are driven simultaneously.

When manually setting cooking conditions while the grill is in operation, setting information of the heating power and time to the completion of the cooking are displayed. (Refer to FIG. 15 (b)) In this case, for part of the segment grouped into grill time/temperature display of the first layer segment (segment of “in cooking” and grill time display), part of the segment grouped into grill menu of the second layer segment, and part of the segment grouped into grill operation/setting display, segments of the both layers are displayed simultaneously without overlapping. A segment configuration is adopted in which automated menu of the grill can be selected and arrangement is such that by pressing the operation key, “grilled whole”→“fillet/dried fish”→“small fish” “grill”→“oven”→“heat”→“grilled whole” can be selected in order. (Refer to FIG. 15 (c)) In this case, for the first layer segment and the second layer segment, segments of the both layers are displayed simultaneously without overlapping.

Thus, segment arrangement is performed in such a way that according to functions and settings, segments are classified by the area and the grouping so that the first layer and the second layer can be displayed in combination such as the segment that informs adjustment of burnt color and adjustment of heating power in each cooking mode of the grill and time display segment of the first layer of “grill”+“in cooking (the first layer)”+“−”+“−”+level pict “□”+“□”+“□”+“(level frame)”+“weak”+“(left triangle)”+“heating power”+“(right triangle)”+“strong” in the manual grill mode, for example. In this case, layout is performed in such way that segments are not overlapped for each function display in order to be able to correspond to the combined lighting driving of the first layer and the second layer.

In addition, descriptions have been given to the case where no segments are driven simultaneously in which the first layer and the second layer segments overlap. To the contrary, in view of attracting attention of the display, it is an effective configuration to make a reverse display of the segment by lighting the segments simultaneously in which the first and the second layers overlap.

As mentioned above, in the present embodiment, it is possible to fully display display information with characters of improved visibility at a display section located in a limited space.

Without using costly dot matrix liquid crystal, it is possible to increase contents of display with an inexpensive configuration (segment liquid crystal, etc.) Further, segments can be standardized and the number of the segment (the number of the port of the microcomputer) can be reduced.

### INDUSTRIAL APPLICABILITY

A heat cooking device according to the present invention can fully secure and display display information with characters of improved visibility at a display section (liquid crystal) located in a limited space.

### REFERENCE SIGNS LIST

A body section
B top board section
C chassis section
D heating means
E operation means
F control means
G display means
N object to be heated
PK sealing material
2 body case
2B front section flange board
2SP upper face opening
2T, 3A flange
6L left IH heat source
6LC left IH heating coil
6LM guidance mark
6R right IH heat source
6RC right IH heating coil
6RM guidance mark
7 center heat source
7M guidance mark
8 electric component chamber
9 roaster heating chamber
10 upper component chamber
11 suction chamber
12 exhaust chamber
13 door
14 exhaust duct
20 upper frame
20A opening
20E through hole
21 top plate
22, 23 heater
24 base
26 protrusion
27 partition board
30 ventilation hole
31L, 31R temperature detection element
32 opening
33L, 33R light receiving section
34L lead wire
36 bonding agent
37 rib
38 protrusion
39 cooling air path
41 cavity section
42 magnetic flux leakage prevention material
43 duct
44 opening
45, 46 ventilation hole
50 container-shaped cover
51 upper and lower partition board
52 space
53 rear partition board
54 blower case
54A ceiling wall
55 duct
55A inlet
56 outlet
57 blower
57A wing section
58 fan section
59 motor
59A partition board
60 front face operation section
61 upper face operation section
62 front face operation frame
63A operation button
64L left operation dial
64R right operation dial
65 center operation dial
66 timer dial
66L left indication light
66R right indication light
67, 68 timer dial
70 right heating power setting operation section
71 left heating power setting operation section
72 center operation section
73 right one-touch key section
82 left one-touch key section
74, 78 weak heating power key
75, 79 medium heating power key
76, 80 strong heating power key
77, 81 3 kW key
83 lock key switch
90, 91, 92, 93 operation button
94 switch button
97R right timer switch
98L left liquid crystal display section
98R right liquid crystal display section
99R right fried foods selection switch
100 integrated display means
100a a first layer liquid crystal panel
100b a second layer liquid crystal panel
100c LED
100d light guide board
100e, 100f substrate
100g display frame
100h holder
101L left heating power display lamp
101R right heating power display lamp
105 front face opening
106 window board
107 center opening
108 tray
109 grill
110 packing
111 inner frame
112 opening
113, 114 gap
115 outer frame
116 exhaust outlet
118 upper end section opening
119 rear section exhaust outlet
120 catalyst for deodorizing
120H catalyst heater
123 front frame body
130 cover
140 ventilation hole
141 front partition board
143, 145 gap
144 vertical wall
150L left side implementation circuit board
150R right side implementation circuit board
151L heat dissipation fin
154, 155 air path
160 auxiliary fan
161 motor
162 partition wall
163 internal space
164, 165 ventilation hole
170 bottom section
171 exhaust outlet and ventilation hole
200 energization control circuit
201 input section
202 output section
203 storage section
204 operation control section
206R right heat source circuit
210L inverter circuit of left IH heat source 6L
210R inverter circuit of right IH heat source 6R
211 heater drive circuit of center heat source 7
212, 213, 214 heater drive circuit
215 drive circuit for driving liquid crystal screen
221 rectification circuit
222 coil
223 smoothing capacitor
224 resonance capacitor
225 IGBT
226 free wheeling diode
227 current detection sensor
228 drive circuit
230, 231 motor drive circuit
232 right display lamp drive circuit
233 left display lamp drive circuit
240 temperature detection circuit
241, 243, 244, 245 temperature detection element
242 temperature detection element for detecting inside temperature
250 substrate case
251 switch
252 electronic component element
253 substrate
254 press button case
254A press button
255 membrane sheet
255A press button support piece

1. A heat cooking device comprising:
a body,
a top plate that covers an upper face of said body and on which an object to be heated is mounted,
heating means that is installed downward of said top plate and heats said object to be heated,
control means that controls operation of said heating means,
operation means that inputs operation and setting information of the cooking device to said control means, and
information means that displays operation information and setting information input by said operation means, or operation conditions information wherein
said information means is a display device such that a display face of information overlapped by a plurality of layers is provided, information displayed by said display face is formed by segments, and said segments are arranged so that said segments provided for displaying information do not overlap when information is simultaneously displayed on said display face in a different layer.

2. A heat cooking device comprising:
a body accommodating heating equipment that heats an object to be heated,
a top plate that is on an upper face of said body and on which said object to be heated is mounted,
control means that controls operation of said heating equipment,
operation section that inputs operation information and/or setting information of cooking to said control means, and
a display section that displays said operation information, setting information, or operation conditions information of said heating equipment, wherein
said display section is a display device such that a display face of information overlapped by a plurality of layers is provided, information displayed by said display face is formed by segments, and said segments are arranged so that said segments of each layer provided for displaying information do not overlap.

3. The heat cooking device of claim 1, wherein
said display device is a two-layer structured transmission type liquid crystal.

4. The heat cooking device of claim 3, wherein
said two-layer structured transmission type liquid crystal performs display in combination of a first layer and a second layer.

5. The heat cooking device of claim 1, wherein
said heating means is an induction heating heater.

6. The heat cooking device of claim 2, wherein
said display device is a two-layer structured transmission type liquid crystal.

7. The heat cooking device of claim 6, wherein
said two-layer structured transmission type liquid crystal performs display in combination of a first layer and a second layer.

8. The heat cooking device of claim 2, wherein said heating means is an induction heating heater.
